(19) United States
(12) Patent Application Publication
(10) Pub. No.: US 2018/0257776 A1
(43) Pub. Date: Sep. 13, 2018

(54) COOLING A POWER SYSTEM FOR AN UNMANNED AERIAL VEHICLE

(71) Applicant: Top Flight Technologies, Inc., Malden, MA (US)

(72) Inventors: Long N. Phan, Winchester, MA (US); Mohammad Imani Nejad, Newton, MA (US); Matthew Sweetland, Bedford, MA (US)

(21) Appl. No.: 15/916,336

(22) Filed: Mar. 9, 2018

Related U.S. Application Data
(60) Provisional application No. 62/469,840, filed on Mar. 10, 2017.

(51) Int. Cl. B64C 39/02; B64C 27/08

(52) U.S. Cl. CPC B64C 39/024; B64C 27/08; B64D 2221/00; B64C 2201/108; B64C 2201/044

(57) ABSTRACT

An unmanned aerial vehicle includes at least one rotor motor configured to drive at least one propeller to rotate; and a micro hybrid generator system configured to provide power to the at least one rotor motor. The micro hybrid generator system includes a rechargeable battery configured to provide power to the at least one rotor motor; a small engine configured to generate mechanical power; and a generator motor coupled to the small engine and configured to generate electrical power from the mechanical power generated by the small engine. The unmanned aerial vehicle also includes a cooling system configured to couple to the micro hybrid generator system. The cooling system includes one or more plates; and a plurality of fins extending from each of the one or more plates. The cooling system is configured to dissipate heat from the micro hybrid generator system.

### RELATED APPLICATION

The present application claims priority to U.S. Provisional Patent Application Ser. No. 62/469,840, filed on Mar. 10, 2017, entitled “COOLING A POWER SYSTEM FOR AN UNMANNED AERIAL VEHICLE,” which application is incorporated herein by reference in its entirety.

### TECHNICAL FIELD

This description relates to cooling a power system.

### BACKGROUND

A multi-rotor unmanned aerial vehicle (UAV) may include rotor motors, one or more propellers coupled to each rotor motor, electronic speed controllers, a flight control system (auto pilot), a remote control (RC) radio control, a frame, one or more power systems, and a battery, such as a lithium polymer (LiPo) or similar type rechargeable battery. Multi-rotor UAVs can perform vertical take-off and landing (VTOL) and are capable of aerial controls with similar maneuverability to single rotor aerial vehicles.

### SUMMARY

Described herein are thermal management strategies employed by an unmanned aerial vehicle (UAV). For example, the UAV may include one or more cooling systems that are configured to provide one or both of active cooling and passive cooling to one or more components of the UAV's power system. The cooling systems may be configured to dissipate heat from components of the micro hybrid generator system that tend to generate considerable amounts of heat.

In one aspect, an unmanned aerial vehicle includes at least one rotor motor configured to drive at least one propeller to rotate, and a micro hybrid generator system configured to provide power to the at least one rotor motor. The micro hybrid generator system includes a rechargeable battery configured to provide power to the at least one rotor motor, a small engine configured to generate mechanical power, and a generator motor coupled to the small engine and configured to generate electrical power from the mechanical power generated by the small engine. The unmanned aerial vehicle also includes a cooling system configured to couple to the micro hybrid generator system. The cooling system includes one or more plates, and a plurality of fins extending from each of the one or more plates. The cooling system is configured to dissipate heat from the micro hybrid generator system.

Implementations can include one or more of the following features.

In some implementations, the one or more plates are configured to couple to the small engine.

In some implementations, at least one of the plates and the corresponding plurality of fins is positioned substantially beneath one of the propellers.

In some implementations, the plurality of fins extend in a perpendicular direction from the one or more plates.

In some implementations, the plates are physically coupled to the small engine.

In some implementations, the plates are coupled to the generator motor.

In some implementations, the cooling system comprises an impeller.

In some implementations, the impeller is coupled to the small engine.

In some implementations, impeller is coupled to the rotor motor.

In some implementations, the plates are coupled to one or more exhaust pipes of the small engine.

In some implementations, plates are formed of metal.

In some implementations, fins comprise multiple groups of fins, each group of fins extending from a corresponding surface of one of the plates.

In some implementations, fins are spaced equally.

In some implementations, fins located at the perimeter of each plate are fanned away from fins located in an interior region of the surface of the plate.

In some implementations, the one or more plates are positioned below the at least one propeller.

In a general aspect, a method includes operating a hybrid energy generation system to provide electrical energy to a rotor motor configured to drive rotation of a propeller of an unmanned aerial vehicle, comprising: generating mechanical energy in an engine of the hybrid electrical energy generation system; in a generator of the hybrid energy generation system, converting the mechanical energy into electrical energy; providing at least some of the electrical energy produced by the generator to a rechargeable battery of the hybrid energy generation system; and one or more of (i) providing at least some of the electrical energy produced by the generator to the rotor motor of the hybrid energy generation system and (ii) providing electrical energy from the rechargeable battery of the hybrid energy generation system to the rotor motor; and cooling the hybrid energy generation by dissipation of heat to a cooling system, the cooling system comprising: one or more plates; and a plurality of fins extending from each of the one or more plates.

The details of one or more embodiments of the subject matter described herein are set forth in the accompanying drawings and the description below. Other features, objects, and advantages of the subject matter will be apparent from the description and drawings, and from the claims.

### DESCRIPTION OF DRAWINGS

FIG. 1 shows a diagram of an example micro hybrid generator system.

FIG. 2 shows a side perspective view of a micro hybrid generator system.

FIG. 3A shows a side view of a micro hybrid generator.

FIG. 3B shows an exploded side view of a micro hybrid generator.

FIGS. 4-7 show an example of a UAV integrated with a micro hybrid generator system that includes a cooling system.

FIG. 8 shows a perspective view of a micro hybrid generator system.

FIG. 9 shows a perspective view of a UAV integrated with a micro hybrid generator system.

FIG. 10 shows a graph comparing specific energy of different UAV power sources.

FIG. 11 shows a graph of market potential vs. endurance for an example UAV with an example micro hybrid generator system.

FIG. 12 shows an example flight pattern of a UAV with a micro hybrid generator system.

FIG. 13 shows a diagram of a micro hybrid generator system with detachable subsystems.

FIG. 14A shows a diagram of a micro hybrid generator system with detachable subsystems integrated as part of a UAV.

FIG. 14B shows a diagram of a micro hybrid generator system with detachable subsystems integrated as part of a ground robot.

FIG. 15 shows a ground robot with a detachable flying pack in operation.

FIG. 16 shows a control system of a micro hybrid generator system.

FIGS. 17-19 show diagrams of a UAV.

FIGS. 20 and 21 show diagrams of portions of a micro hybrid generator system.

FIGS. 22A and 22B show diagrams of portions of a micro hybrid generator system.

FIG. 23 shows a diagram of a portion of an engine.

### DETAILED DESCRIPTION

Described herein is an unmanned aerial vehicle (UAV) that employs one or more thermal management strategies. For example, the UAV includes one or more cooling systems that are configured to provide one or both of active cooling and passive cooling to one or more components of the UAV's power system. The cooling systems may be configured to operate while the UAV is in flight and/or while the UAV is stationed on the ground (e.g., pre-flight, post-flight, and/or while performing ground-based operations, etc.).

In some implementations, the UAV may be powered by a micro hybrid generator system. The micro hybrid generator system can provide a small portable micro hybrid generator power source with energy conversion efficiency. The micro hybrid generator system can be used to overcome the weight of the vehicle, the micro hybrid generator drive, and fuel used to provide extended endurance and payload capabilities in UAV applications.

The micro hybrid generator system can include two separate power systems. A first power system included as part of the micro hybrid generator system can be a small and efficient gasoline powered engine coupled to a generator motor. The first power system can serve as a primary source of power of the micro hybrid generator system. A second power system, included as part of the micro hybrid generator system, can be a high specific energy rechargeable battery. Together, the first power system and the second power system combine to form a high energy continuous power source and with high peak power availability for a UAV. In some examples, one of the first power system and the second power system can serve as a back-up power source of the micro hybrid generator system if the other power system experiences a failure.

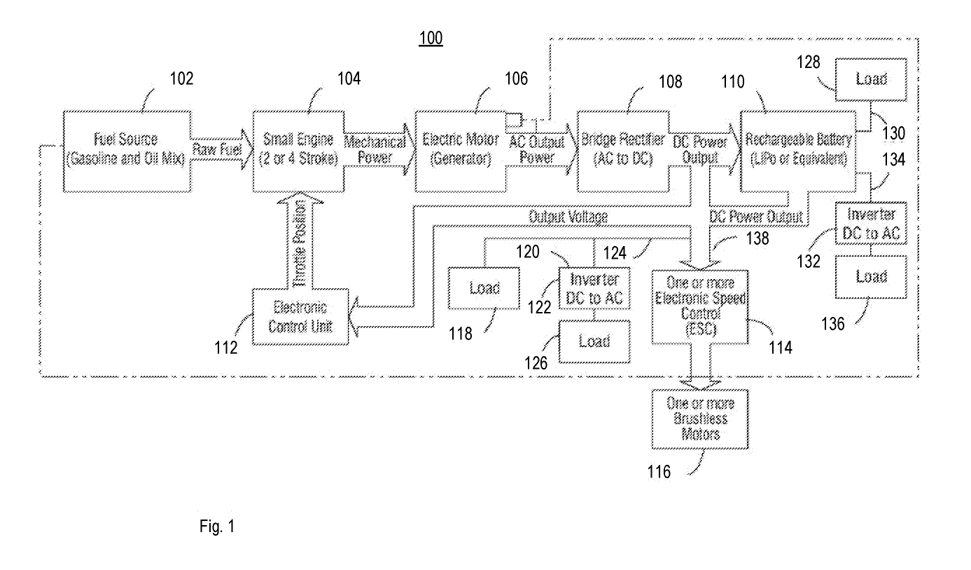

FIG. 1 shows a diagram of an example micro hybrid generator system 100. The micro hybrid generator system 100 includes a fuel source 102 (e.g., a vessel) for storing gasoline, a mixture of gasoline and oil mixture, or similar type fuel or mixture. The fuel source 102 provides fuel to a small engine 104 of a first power system. The small engine 104 can use the fuel provided by the fuel source 102 to generate mechanical energy. In some examples, the small engine 104 can have dimensions of about 12″ by 11″ by 6″ and a weight of about 3.5 pounds to allow for integration in a UAV. In some examples, the small engine 104 may be an HWC/Zenoah G29 RCE 3D Extreme available from Zenoah, 1-9 Minamidai Kawagoe, Saitama 350-2025, Japan. The micro hybrid generator system 100 also includes a generator motor 106 coupled to the small engine 104. The generator motor 106 functions to generate AC output power using mechanical power generated by the small engine 104. In some examples, a shaft of the small engine 104 includes a fan that dissipates heat away from the small engine 104. In some examples, the generator motor 106 is coupled to the small engine 104 through a polyurethane coupling.

In some examples, the micro hybrid generator system 100 can provide 1.8 kW of power. The micro hybrid generator system 100 can include a small engine 104 that can provide up to 2.25 kW and weighs approximately 1.5 kg. In some examples, the small engine 104 may be a Zenoah® G29RC Extreme engine. The micro hybrid generator system 100 can include a generator motor 106 that is a brushless motor, such as a 380 Kv, 8 mm shaft, part number 5035-380, available from Scorpion Precision Industry®.

In some examples, the micro hybrid generator system 100 can provide 10 kW of power. The micro hybrid generator system 100 can include a small engine 104 that provides approximately between 11 and 12.25 kW and weighs approximately 3.2 kg. In some examples, the small engine 104 is a Desert Aircraft® D-150. The micro hybrid generator system 100 can include a generator motor 106, such as a Joby Motors® JM1 motor.

The micro hybrid generator system 100 includes a bridge rectifier 108 and a rechargeable battery 110. The bridge rectifier 108 is coupled between the generator motor 106 and the rechargeable battery 110 and converts the AC output of the generator motor 106 to DC power to charge the rechargeable battery 110 or provide DC power to load 118 by line 120 or power to DC-to-AC inverter 122 by line 124 to provide AC power to load 126. The rechargeable battery 110 may provide DC power to load 128 by line 130 or to DC-to-AC inverter 132 by line 134 to provide AC power to load 136. In some examples, an output of the bridge rectifier 108 and/or the rechargeable battery 110 of micro hybrid generator system 100 is provided by line 138 to one or more electronic speed control devices (ESC) 114 integrated in one or more rotor motors 116 as part of a UAV. The ESC 114 can control the DC power provided by bridge rectifier 108 and/or rechargeable battery 110 to one or more rotor motors provided by generator motor 106. In some examples, the ESC 114 can be a T-Motor® ESC 45A (2-6S) with SimonK. In some examples, the bridge rectifier 108 can be a model #MSD100-08, diode bridge 800V 100A SM3, available from Microsemi Power Products Group®. In some examples, active rectification can be applied to improve efficiency of the micro hybrid generator system.

In some examples, the ESC 114 can control an amount of power provided to one or more rotor motors 116 in response to input received from an operator. For example, if an operator provides input to move a UAV to the right, then the ESC 114 can provide less power to rotor motors 116 on the right of the UAV to cause the rotor motors to spin propellers on the right side of the UAV slower than propellers on the left side of the UAV. As power is provided at varying levels to one or more rotor motors 116, a load (e.g., an amount of power provided to the one or more rotor motors 116) can change in response to input received from an operator.

In some examples, the rechargeable battery 110 may be a LiPo battery, providing 3000 mAh, 22.2V 65C, Model PLU65-30006, available from Pulse Ultra Lipo®, China. In some examples, the rechargeable battery 110 may be a lithium sulfur (LiSu) rechargeable battery or similar type of rechargeable battery.

The micro hybrid generator system 100 includes an electronic control unit (ECU) 112. The ECU 112, and other applicable systems described herein, can be implemented as a computer system, a plurality of computer systems, or parts of a computer system or a plurality of computer systems. The computer system may include a processor, memory, non-volatile storage, and an interface. A typical computer system will usually include at least a processor, memory, and a device (e.g., a bus) coupling the memory to the processor. In some examples, the processor may be a general-purpose central processing unit (CPU), such as a microprocessor, or a special-purpose processor, such as a microcontroller.

In some examples, the memory can include random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data may be written, by a direct memory access process, into memory during execution of software on the computer system. The non-volatile storage can be local, remote, or distributed. The non-volatile storage may be optional because systems can be created with all applicable data available in memory.

Software is typically stored in the non-volatile storage. In some examples (e.g., for large programs), it may not be practical to store the entire program in the memory. Nevertheless, it should be understood that the software may be moved to a computer-readable location appropriate for processing, and for illustrative purposes, that location is referred to as the memory herein. Even when software is moved to the memory for execution, the processor will typically make use of hardware registers to store values associated with the software, and local cache that, in some examples, serves to speed up execution. As used herein, a software program may be stored at an applicable known or convenient location (e.g., from non-volatile storage to hardware registers) when the software program is referred to as “implemented in a computer-readable storage medium.” A processor is considered to be “configured to execute a program” when at least one value associated with the program is stored in a register readable by the processor.

In some examples of operation, a computer system can be controlled by operating system software, such as a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. In some examples, the I/O devices can include a keyboard, a mouse or other pointing device, disk drives, printers, a scanner, and other I/O devices, including a display device. In some examples, the display device can include a cathode ray tube (CRT), liquid crystal display (LCD), or some other applicable known or convenient display device. The interface can include one or more of a modem or network interface. It will be appreciated that a modem or network interface can be considered to be part of the computer system. The interface can include one or more of an analog modem, isdn modem, cable modem, token ring interface, Ethernet interface, satellite transmission interface (e.g. “direct PC”), or other interfaces for coupling a computer system to other computer systems. Interfaces enable computer systems and other devices to be coupled together in a network.

A computer system can be implemented as a module, as part of a module, or through multiple modules. As used herein, a module can include one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the module's functionality, or the like. As such, a first module and a second module can have one or more dedicated processors, or a first module and a second module can share one or more processors with one another or other modules. Depending upon implementation-specific or other considerations, in some examples, a module can be centralized or its functionality distributed. A module can include hardware, firmware, or software embodied in a computer-readable medium for execution by the processor. The processor can transform data into new data using implemented data structures and methods, such as is described with reference to the figures included herein.

The ECU 112 is coupled to the bridge rectifier 108 and the rechargeable battery 110. The ECU 112 can be configured to measure the AC voltage of the output of the generator motor 106, which is directly proportional to the revolutions per minute (RPM) of the small engine 104, and compares it to the DC power output of the bridge rectifier 108. The ECU 112 can control the throttle of the small engine 104 to cause the DC power output of the bridge rectifier 108 to increase or decrease as the load changes (e.g., a load of one or more electric motors 116 or one or more of loads 118, 126, 128, and 136). In some examples, the ECU 112 can be an Arduino® MEGA 2560 Board R3, available from China. In various embodiments, a load of one or more electric motors 116 can change as the ESC 114 changes an amount of power provided to the electric motors 116. For example, if a user inputs to increase the power provided to the electric motors 116 subsequently causing the ESC 114 to provide more power to the electric motors 116, then the ECU 112 can increase the throttle of the small engine 104 to cause the production of more power to be provided to the electronic motors 116.

The ECU 112 can function to maintain voltage output of loads by reading the sensed analog voltage, converting the sensed analog voltage to ADC counts, comparing the count to that corresponding to a desired voltage, and increasing or decreasing the throttle of the small engine 104 according to the programmed gain if the result is outside of the dead band.

In some examples, the micro hybrid generator system 100 can provide about 1,800 watts of continuous power, 10,000 watts of instantaneous power (e.g., 6 S with 16,000 mAh pulse battery) and has a 1,500 Wh/kg gasoline conversion rate. In some examples, the micro hybrid generator system 100 has dimensions of about 12″ by 12″ by 12″ and a weight of about 8 lbs.

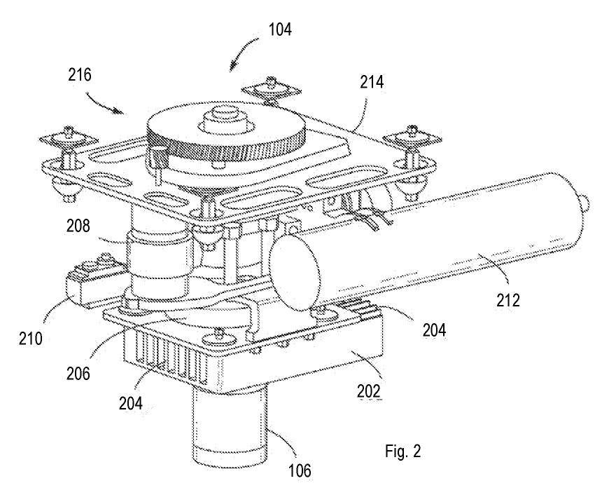

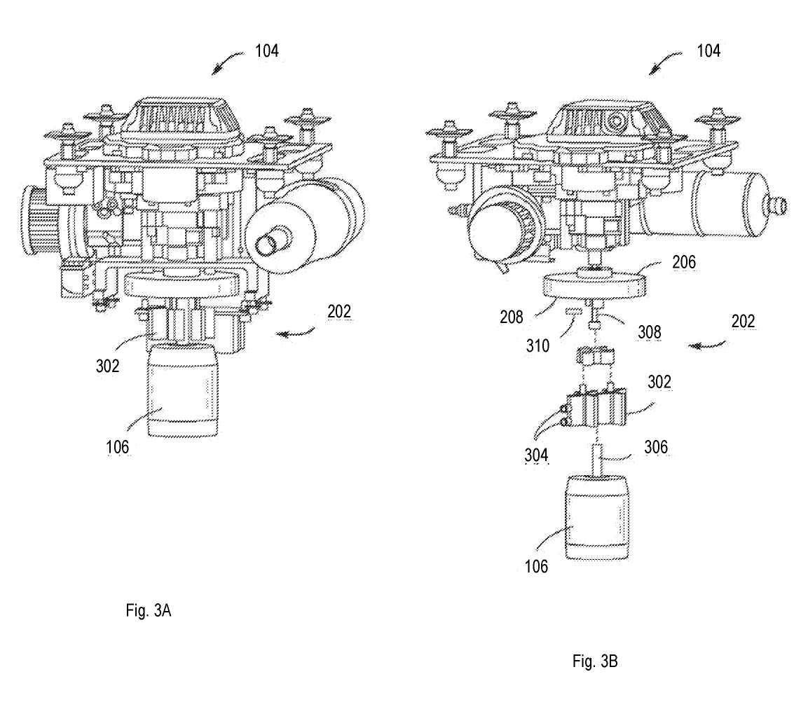

FIG. 2 shows a side perspective view of a micro hybrid generator system 100. FIG. 3A shows a side view of a micro hybrid generator 100. FIG. 3B shows an exploded side view of a micro hybrid generator 100. The micro hybrid generator system 100 includes a small engine 104 coupled to generator motor 106.

In some examples, one or more thermal management strategies can be employed in order to provide active cooling, passive cooling, or both to one or more components of the micro hybrid generator system 100. High specific power components are sometimes susceptible to overheating (e.g., because thermal dissipation is usually proportional to surface area). In addition, internal combustion can be an inherently inefficient process that creates heat.

Active cooling systems are those that involve the use of energy in order to cool something. For example, an active cooling system may employ one or more fans, such as a centrifugal fan. The centrifugal fan can be coupled to an engine shaft of the small engine 104 so that the fan spins at the same RPM as the engine, thus producing significant air flow. The centrifugal fan can be positioned such that the air flow is directed over certain components of the engine (e.g., the hottest parts of the engine) such as the cylinder heads of the small engine 104. Air flow generated by the flying motion of the UAV can also be used to cool the micro hybrid generator system 100. For instance, air pushed by the rotors of the UAV (e.g., referred to as propeller wash) can be used to cool components of the micro hybrid generator system 100.

In some implementations, passive cooling strategies can be used alone or in combination with active cooling strategies in order to cool components of the micro hybrid generator system 100. Passive cooling systems are those that utilize heat dissipation techniques to transfer heat from one location (e.g., a component to be cooled) to another location (e.g., a location where the heat can be dissipated over time). In some examples, one or more components of the micro hybrid generator system 100 can be positioned in contact with thermally conductive heat sinks, thus reducing the operating temperature of the components. For instance, the frame of the UAV can be formed of a thermally conductive material, such as aluminum, which can act as a heat sink.

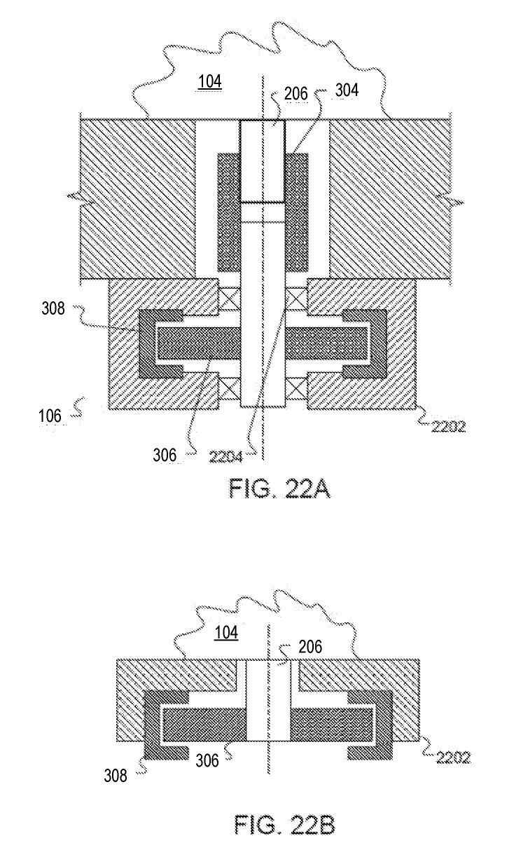

In one embodiment, the small engine 104 includes a coupling/cooling device 202 which provides coupling of the shaft of the generator motor 106 to the shaft of small engine 104 and also provides cooling with sink fins 204. For example, FIGS. 3A and 3B show in further detail one embodiment of coupling/cooling device 202, which includes coupling/fan 302 with set screws 304 that couple shaft 306 of generator motor 106 and shaft 308 of small engine 104. Coupling/cooling device 202 may also include rubber coupling ring (2202 of FIG. 22A).

In some examples, the micro hybrid generator system 100 includes components to facilitate transfer of heat away from the micro hybrid generator system 100 and/or is integrated within a UAV to increase airflow over components that produce heat. For example, the hybrid generator system 100 can include cooling fins on specific components (e.g. the rectifier) to transfer heat away from the micro hybrid generator system 100. In some examples, the micro hybrid generator system 100 includes components and is integrated within a UAV to cause heat to be transferred towards the exterior of the UAV.

In some examples, the micro hybrid generator system 100 and/or a UAV integrating the micro hybrid generator system 100 is configured to allow 406 cubic feet per minute of airflow across at least one component of the micro hybrid generator system 100. A small engine 104 of the micro hybrid generator system 100 can be run at an operating temperature 150° C. and if an ambient temperature in which the micro hybrid generator system 100, in order to remove heat generated by the small engine 104, an airflow of 406 cubic feet per minute is achieved across at least the small engine 104. Further, in some examples, the small engine 104 is operated at 12 kW and generates 49 kW of waste heat (e.g. each head of the small engine produces 24.5 kW of waste heat). In some examples, engine heads of the small engine 104 of the micro hybrid generator system 100 are coupled to electric ducted fans to concentrate airflow over the engine heads. For example, 406 cubic feet per minute airflow can be achieved over engine heads of the small engine 104 using electric ducted fans.

In some examples, the micro hybrid generator system 100 is integrated as part of a UAV using a dual vibration damping system. A small engine 104 of the micro hybrid generator system can utilize couplings to serve as dual vibration damping systems. In some examples, the small engine 104 produces a mean torque of 1.68 Nm at 10,000 RPM. In some examples, a urethane coupling is used to couple at least part of the micro hybrid generator system 100 to a UAV. Further, in some examples, the urethane coupling can have a durometer value of between 90 A to 75 D. Example urethane couplings used to secure at least part of the micro hybrid generator system 100 to a UAV include L42 Urethane, L100 Urethane, L167 Urethane, and L315 Urethane. Urethane couplings used to secure at least part of the micro hybrid generator system 100 to a UAV can have a tensile strength between 20 MPa and 62.0 MPa, between 270 to 800% elongation at breaking, a modulus between 2.8 MPa and 32 MPa, an abrasion index between 110% and 435%, and a tear strength split between 12.2 kN/m and 192.2 kN/m.

The small engine 104 also includes a fly wheel 206 which can reduce mechanical noise and/or engine vibration. In some examples, small engine 104 includes a Hall-Effect sensor (310 of FIG. 3A) and a Hall Effect magnet coupled to fly wheel 206, as shown. In some examples, the Hall-effect sensor 310 may be available from RCexl Min Tachometer®, Zhejiang Province, China.

When small engine 104 is operational, fly wheel 206 spins and generates a voltage which is directly proportional to the revolutions per minute of fly wheel 206. This voltage is measured by Hall-effect sensor 310 and is input into an ECU 112. The ECU 112 compares the measured voltage to the voltage output by generator motor 106. ECU 112 will then control the throttle of either or both the generator motor 106 and the small engine 104 to increase or decrease the voltage as needed to supply power to one or more of loads 118, 126, 128, and/or 136 or one or more rotor motors 116.

Small engine 104 may also include a starter motor 208, servo 210, muffler 212, and vibrational mount 214.

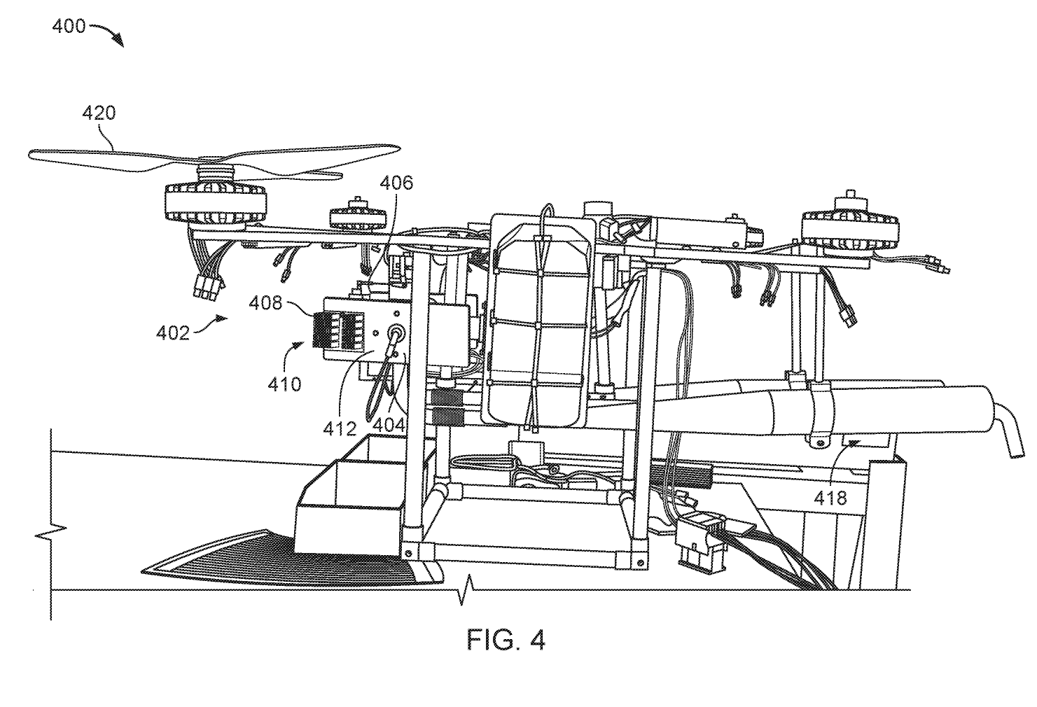

FIGS. 4-7 show an example of a UAV 400 that includes a power system and a cooling system 402 for cooling the power system. In the illustrated example, the UAV 400 employs a micro hybrid generator system (e.g., the micro hybrid generator system 100 of FIG. 1) for powering the UAV 400, although it should be understood that in some implementations, the cooling system 402 can be used for providing cooling to other types of power systems (e.g., such as a gasoline turbine coupled to a generator motor, as described in more detail below). In this example, the cooling system 402 is configured to cool one or more components of the micro hybrid generator system 100 by utilizing heat dissipation techniques.

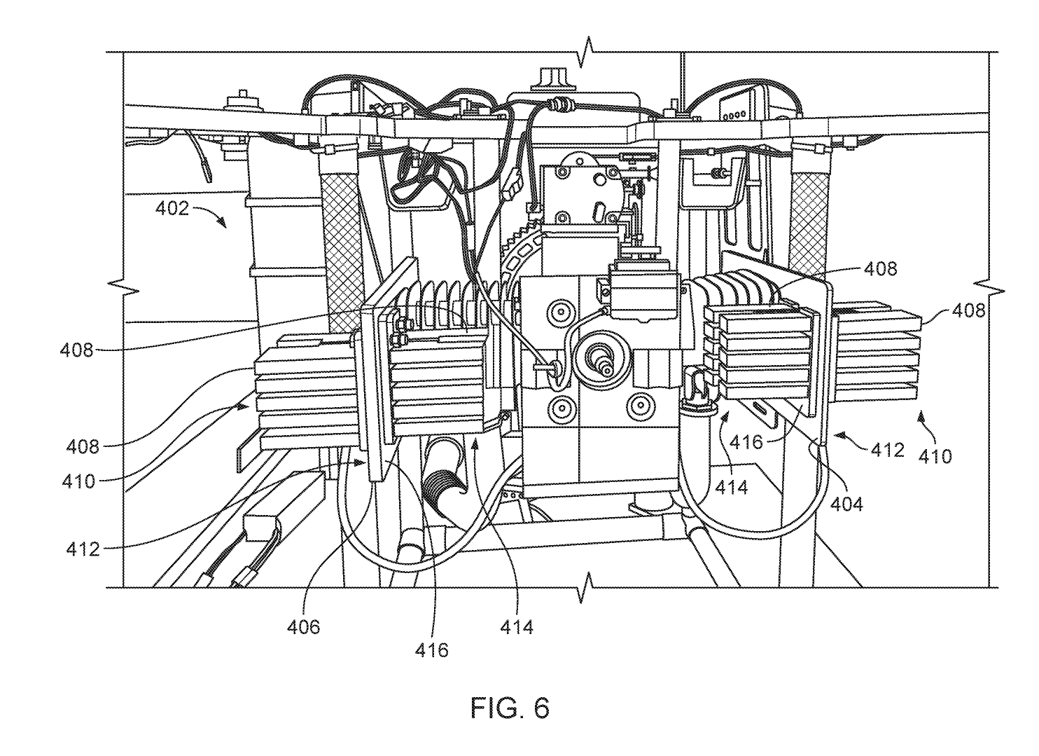

In the illustrated example, the cooling system 402 includes a first plate 404 and a second plate 406, each plate 404, 406 including fins 408. The fins 408 of each plate 404, 406 are arranged in a first group of fins 410 that extend from a first surface 412 of the respective plate 404, 406 and a second group of fins (414 of FIG. 6) that extend from a second surface (416 of FIG. 6) of the respective plate 404, 406. The fins 408 extend outward, e.g., in a perpendicular direction from the respective plate 404, 406 to which they are attached.

The fins 408 are designed and arranged to increase the rate of heat transfer away from the respective plate 404, 406 by increasing convection (e.g., increasing the convective surface area). The convective surface area may increase as additional fins 408 are included. As such, heat transfer generally increases as additional fins 408 are included.

The cooling system 402 may be positioned at or near components of the micro hybrid generator system 100 that tend to generate considerable amounts of heat (e.g., components that generate the most heat). In this way, the cooling provided by the cooling system 402 can be utilized at the location of most need. In the illustrated example, the plates 404, 406 are coupled to the small engine 104, and in particular, to the cylinder heads of the small engine 104, although in some implementations, the plates 404, 406 may be coupled/mounted to other components of the small engine 104. In some implementations, the plates 404, 406 are physically coupled to the small engine 104 by one or more fasteners (e.g., screws, bolts, welded in place, etc.). In some implementations, the plates 404, 406 are not physically coupled to the small engine 104, but rather are coupled in terms of heat transfer. For example, the plates 404, 406 may reside beside the small engine 104 such that surfaces of the plates 404, 406 and the small engine 104 are in physical contact with each other or are in close proximity to each other, thereby allowing for transfer of heat therebetween. The cylinder head is where the engine pistons compress the contents of the cylinder, thereby causing combustion to occur. Such compression and combustion produces large amounts of heat. The heat is transferred by convection to the portions of the plates 404, 406 to which the cylinder head is coupled. In turn, the heat is transferred by convection along the plate 404, 406 to the respective fins 408. At least some of the heat may be dissipated as it is transferred along the plate 404, 406 toward the fins 408. The remainder of the heat is transferred to the fins 408, where the relatively large collective surface area of the fins 408 allows the heat to dissipate relatively quickly (e.g., as compared to the rate of dissipation that would occur in the absence of fins 408). The rate of dissipation is also improved simply by allowing the fins 408 to dissipate the heat at locations away from the heat-generating components of the micro hybrid generator system 100.

In some implementations, the cooling system 402 may be positioned at or near components of the micro hybrid generator system 100 other than the small engine 104. For example, in some implementations, the plates 404, 406 may be coupled to the generator motor 106. In some implementations, fins may be disposed directly on the small engine 104 and/or the generator 106. Such fins may be instead of or in addition to the fins 408 of the plates 404, 406.

In some implementations, an impeller is also used to assist in cooling components of the micro hybrid generator system 100. The impeller may be part of the cooling system 402, provided as a separate component, etc. The impeller may be a rotating component that is positioned at or near the components of the micro hybrid generator system 100 to be cooled, such as the small engine 104 and/or the generator motor 106. The impeller may be configured to blow air (e.g., hot ambient air) away from the small engine 104 and/or the generator motor 106 to allow the heat to be dissipated at other lower-temperature areas.

Exhaust pipes 418 of the micro hybrid generator system 100 can also be situated near the locations where the plates 404, 406 are coupled. Exhaust from the small engine 104 tends to generate a large amount of heat. As such, the heat caused by the exhaust can also be transferred to the plates 404, 406 and then toward the fins 408 by the cooling system 402.

The plates 404, 406 and the fins 408 may be made of one or more materials suitable for dissipating heat at an appropriate rate. The degree and rate of heat transfer in an object may be based at least in part on the amount of conduction of the object. Materials with a relatively high thermal conductivity can allow heat to pass through quickly, thereby maximizing the rate of heat dissipation. In some implementations, multiple material types may be used to assist with the transfer of heat. In the illustrated example, the plates 404, 406 are made from one metallic material (e.g., copper) and the fins 408 are made from another type of metallic material (e.g., aluminum), both of which have a relatively high thermal conductivity.

While the cooling system 402 illustrated in FIGS. 4-7 shows each group of fins 410, 414 as including over one hundred fins 408 (e.g., approximately eighty-five fins 408 extending from the first surface 412 and approximately eighty-five fins 408 extending from the second surface 416), any number of fins 408 may be included. In some implementations, additional or fewer groups of fins 408 could be employed. In some implementations, the particular number of fins 408 employed may be based on experimentation so as to increase (e.g., maximize) the degree of heat transfer. In some implementations, the particular configuration of the fins 408 (e.g., the spacing, grouping, orientation, tilt, or other configuration) may be such that heat transfer is increased or maximized. The particular configuration employed may be based on calculation and/or experimentation to determine an appropriate configuration for the particular power system employed.

In the example shown in FIGS. 4-7, the plates 404, 406 may have dimensions of approximately 200 mm by 100 mm, and the fins 408 may be approximately 100 mm long. However, the sizes of the plates 404, 406 and/or fins 408 may depend on the particular characteristics of the UAV 400 and/or the particular applications for which the UAV 400 is to be used. Similarly, the arrangement of the plates 404, 406 and/or fins 408, as well as the number of plates and/or fins employed in the cooling system 402, may likewise depend on the particular characteristics of the UAV 400 and/or the particular applications for which the UAV 400 is to be used.

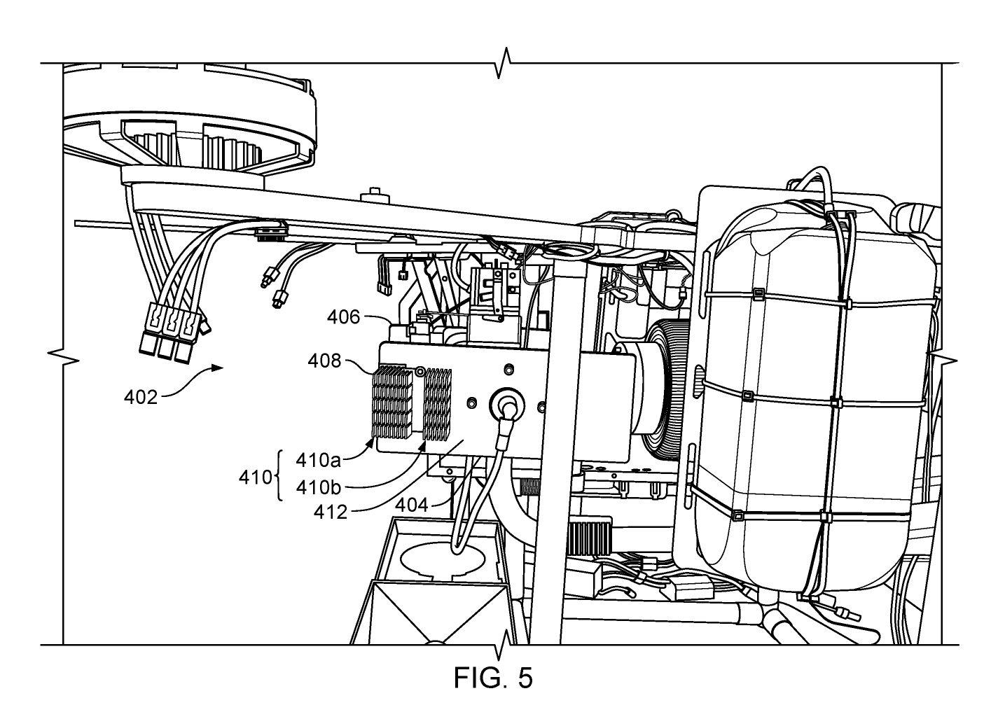

Referring to FIGS. 5 and 6, in the illustrated example, each plate 404, 406 includes a first group of fins 410 extending from a first surface 412 of the plate 404, 406 (e.g., the fins 408 shown in FIG. 5) and a second group of fins 414 extending from a second surface 416 of the plate 404, 406 (e.g., the surface opposite the first surface 412, not shown in FIG. 5). The first group of fins 410 is broken up into two subgroups—a first subgroup 410a that includes approximately fifty fins 408 and a second subgroup 410b that includes approximately thirty-five fins 408. The fins 408 of each subgroup 410a, 410b are arranged in a matrix pattern of rows and columns. The fins 408 of the first subgroup 410a are arranged in five rows of ten fins 408 each (e.g., a ten by five matrix), and the fins 408 of the second subgroup 410b are arranged in five rows of seven fins 408 each (e.g., a seven by five matrix).

The fins 408 of each row are spaced apart from each other, and the rows of fins 408 are also spaced apart from each other. Such spacing may be chosen to provide sufficient ambient space for the heat to dissipate into the air. In general, the fins 408 of each row are approximately equidistantly spaced. However, in some implementations, one or more of the fins 408 may have a fanned configuration with respect to each other in order to provide additional space therebetween (e.g., to maximize the efficacy of heat transfer). For example, perimeter fins (e.g., the fins 408 closest to the outer edge of the plate 404 and the fins 408 closest to the middle of the plate 404 in FIG. 5) may be fanned away from the other fins 408 of the respective subgroup 410a, 410b to increase ambient space and maximize heat transfer.

While the cooling system 402 has largely been described as one that cools the micro hybrid generator system 100 by improving the dissipation of heat away from the heat-generating components, the cooling system 402 may also employ other types of cooling. As described above, the rate of heat dissipation is improved by situating the fins 408 at locations away from the heat-generating components (e.g., the small engine 104) of the micro hybrid generator system 100. The particular location at which the cooling system 402 is positioned may be strategically chosen to maximize cooling.

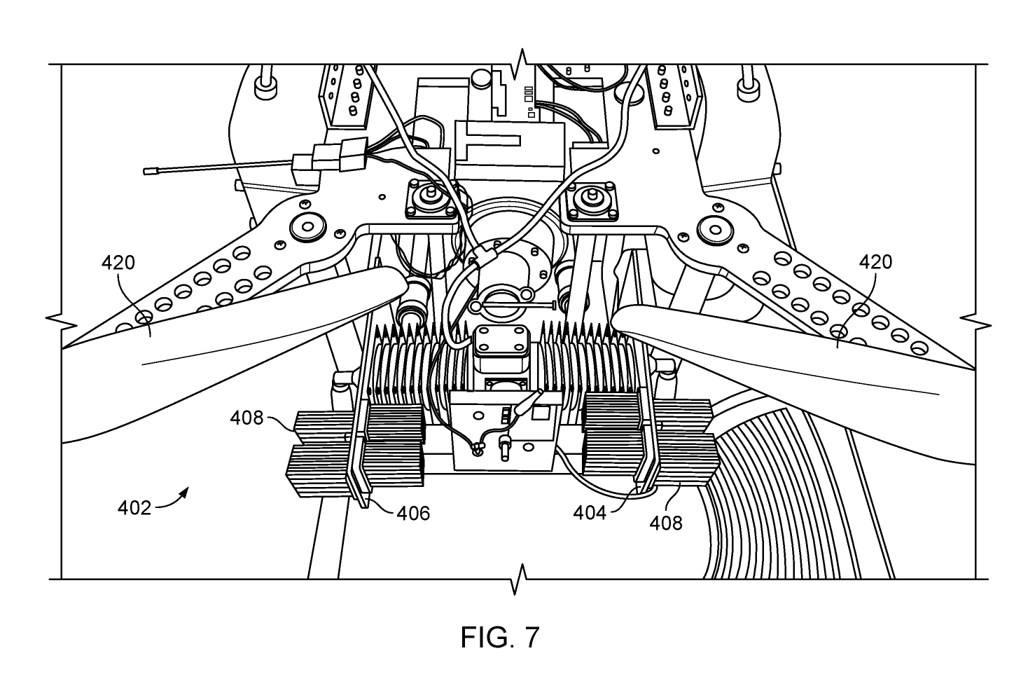

As illustrated in FIG. 7, one or both of the plates 404, 406 and corresponding fins 408 may be situated substantially beneath a respective one of the propellers 420. The spinning of the propellers 420 causes a current of air (e.g., sometimes referred to as propeller wash) to be created. The propeller wash emanates in a substantially downwards direction with respect to the propellers 420, thereby resulting in a counter force that causes the UAV 400 to be lifted into the air. By positioning one or both of the plates 404, 406 and corresponding fins 408 substantially beneath the respective propeller 420, the propeller 420 can act as a fan that cools the components of the cooling system 402. In this way, the propeller wash that is inherently created by the UAV 400 can be taken advantage of for cooling purposes.

The precise positioning of the cooling system 402 may depend on the characteristics of the particular propellers 420 of the UAV 400. In some examples, the dimensions of the propellers 420 may cause the propeller wash to be focused toward a particular location beneath the propellers 420. In some examples, the plates 404, 406 and corresponding fins 408 can be positioned at a location where the speed of the air currents is maximized. In some examples, the components of the cooling system 402 that require the most cooling assistance, the components of the cooling system 402 that may benefit the most from the propeller wash, etc. may be positioned in such high airflow locations. For example, the fins 408 of the cooling system 402 may be positioned substantially beneath the circumference defined by the spinning propellers 420 (e.g., as shown in FIG. 7). Such a location may experience the highest degree of propeller wash. The fins 408 may especially benefit from being situated in such a location (e.g., as compared to the plates 404, 406 being so situated) because the spaces between the fins 408 can be rid of the dissipated heat.

The cooling systems 402 may be positioned such that cooling is maximized without negatively affecting the flight capabilities and/or flight efficiency of the UAV 400. For example, the cooling system 402 may be positioned at a location at which a preferred balance of cooling performance and negative impact on lift can be achieved. In some implementations, the distance between the propeller and the respective plate 404, 406 and fins 408 can be chosen to maintain such a balance.

While the cooling system 402 illustrated in FIGS. 4-7 is shown as having two plates 404, 406 each including a plurality of fins 408, any number of plates may be used. In some implementations, the cooling system 402 may include a number of plates equal to the number of propellers 420 of the UAV 400. For example, the cooling system 402 may include six plates each including a plurality of fins 408.

While the illustrated plates 404, 406 are shown as having substantially similar configurations (e.g., each plate 404, 406 is illustrated as having approximately the same number of fins 408 with substantially the same configuration), in some implementations, the various plates 404, 406 may have different plate configurations and/or fin configurations. In some implementations, the cooling system 402 may include additional plates and fins 408 that are affixed to other portions of the micro hybrid generated system 100. Plates and fins 408 that are affixed to components that generate relatively less heat (e.g., relatively less heat than the small engine 104 generates) may be configured depending on the particular cooling requirements. For example, additional plates may have different (e.g., smaller) dimensions and/or may include a different number of (e.g., fewer) fins 408 than the plates 404, 406 shown in FIGS. 4-7. The configuration of such additional plates and fins 408 may be chosen to maximize the cooling provided to the micro hybrid generator system 100 without affecting the efficiency and/or range of the UAV 400 to an unacceptable degree.

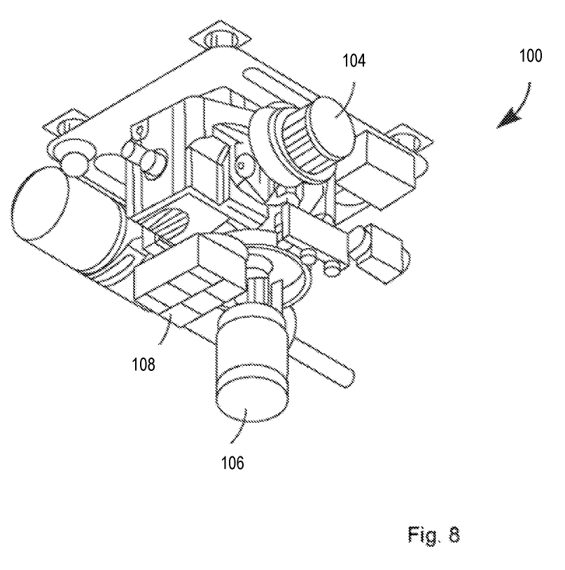

FIG. 8 shows a perspective view of a micro hybrid generator system 100. The micro hybrid generator system 100 includes a small motor 104 and generator motor 106 coupled to a bridge rectifier 108.

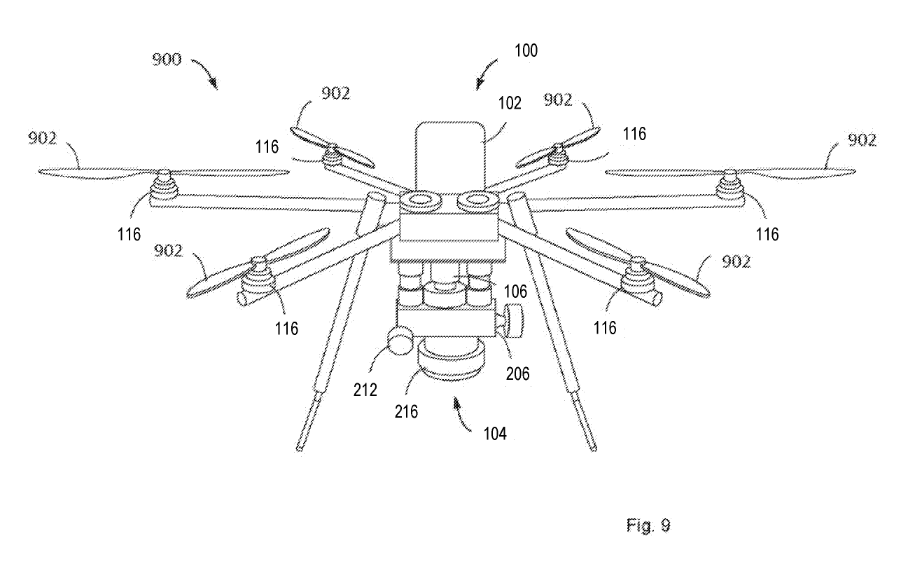

FIG. 9 shows a perspective view of a UAV 900 integrated with a micro hybrid generator system 100. The UAV 900 includes six rotor motors 116 each coupled to propellers 902, however it is appreciated that a UAV integrated with a micro hybrid generator system 100 can include more or fewer rotor motors and propellers. The UAV 900 can include a Px4 flight controller manufactured by Pixhawk®.

In some examples, the small engine 104 may be started using an electric starter (216 of FIGS. 2 and 9). Fuel source 102 can deliver fuel to small engine 104 to spin its rotor shaft directly coupled to generator motor 106 (e.g., as shown in FIG. 3) and applies a force to generator motor 106. The spinning of generator motor 106 generates electricity and the power generated by motor generator 106 is proportional to the power applied by shaft of small engine 104. In some examples, a target rotational speed of generator motor 106 is determined based on the KV (rpm/V) of generator motor 106. For example, if a target voltage of 25 Volt DC is desired, the rating of generator motor 106 may be about 400 KV. The rotational speed of the small engine 104 may be determined by the following equations:

RPM=KV(RPM/Volt)×Target Voltage(VDC) (1)

RPM=400 KV×25 VDC (2)

RPM=10,000 (3)

In this example, for generator motor 106 to generate 25 VDC output, the shaft of generator motor 106 coupled to the shaft of small engine 104 needs to spin at about 10,000 RPM.

As the load (e.g., one or more motors 116 or one or more of loads 118, 126, 128, and/or 136) is applied to the output of generator motor 106, the voltage output of the micro hybrid generator system 100 will drop, thereby causing the speed of small engine 104 and generator motor 106 to be reduced. In some examples, ECU 112 can be used to help regulate the throttle of small engine 104 to maintain a consistent output voltage that varies with loads. ECU 112 can act in a manner similar to that of a standard governor for gasoline engines, but instead of regulating an RPM, the ECU 112 can regulate a target voltage output of either or both a bridge rectifier and a generator motor 106 based on a closed loop feedback controller.

Power output from generator motor 106 can be in the form of alternating current (AC) which may need to be rectified by bridge rectifier 108. Bridge rectifier 108 can convert the AC power into direct current (DC) power, as discussed above. In some examples, the output power of the micro hybrid generator system 100 can be placed in a “serial hybrid” configuration, where the generator power output by generator motor 106 may be available to charge the rechargeable battery 110 or provide power to another external load.

In operation, there can be at least two available power sources when the micro hybrid generator system 100 is functioning. A primary source can be from the generator motor 106 through directly from the bridge rectifier and a secondary power source can be from the rechargeable battery 110. Therefore, a combination of continuous power availability and high peak power availability is provided, which may be especially well-suited for UAV applications or portable generator applications. In cases where either primary power source (e.g., generator motor 106) is not available, system 100 can still continue to operate for a short period of time using power from rechargeable battery 110, thereby allowing a UAV to sustain safety strategy, such as an emergency landing.

When micro hybrid generator system 100 is used for UAVs, the following conditions can be met to operate the UAV effectively and efficiently: 1) the total continuous power (watts) can be greater than power required to sustain UAV flight, 2) the power required to sustain a UAV flight is a function of the total weight of the vehicle, the total weight of the hybrid engine, the total weight of fuel, and the total weight of the payload), where:

Total Weight(gram)=vehicle dry weight+small engine 104 weight+fuel weight+payload (4)

and, 3) based on the vehicle configuration and aerodynamics, a particular vehicle will have an efficiency rating (grams/watt) of 11, where:

Total Power Required to Fly=η×Weight(gram) (5)

In examples in which the power required to sustain flight is greater than the available continuous power, the available power or total energy may be based on the size and configuration of the rechargeable battery 110. A configuration of the rechargeable battery 110 can be based on a cell configuration of the rechargeable battery 110, a cell rating of the rechargeable battery 110, and/or total mAh of the rechargeable battery 110. In some examples, for a 6 S, 16000 mAh, 25C battery pack, the total energy is determined by the following equations:

Total Energy=Voltage×mAh=25 VDC(6S)×16000 mAh=400 Watt*Hours (6)

Peak Power Availability=Voltage×mAh×C Rating=25 VDC×16000mAh×25 C10,400Watts (7)

Total Peak Time=400Watt*Hours/10,400Watts=138.4 secs (8)

Further, in some examples, the rechargeable battery 110 may be able to provide 10,400 Watts of power for 138.4 seconds in the event of primary power failure from small engine 104. Additionally, the rechargeable battery 110 may be able to provide up to 10,400 Watts of available power for flight or payload needs instantaneous peak power for short periods of time needed for aggressive maneuvers.

The result is micro hybrid generator system 100, when coupled to a UAV, efficiently and effectively provides power to fly and maneuver the UAV for extended periods of time with higher payloads than conventional multi-rotor UAVs. In some examples, the micro hybrid generator system 100 can provide a loaded (e.g., 3 lb. load) flight time of up to about 2 hours 5 minutes, and an unloaded flight time of about 2 hours and 35 minutes. Moreover, in the event that the fuel source runs out or the small engine 104 and/or he generator motor 106 malfunctions, the micro hybrid generator system 100 can use the rechargeable battery 110 to provide enough power to allow the UAV to perform a safe landing. In some examples, the rechargeable battery 110 can provide instantaneous peak power to a UAV for aggressive maneuvers, for avoiding objects, or threats, and the like.

In some examples, the micro hybrid generator system 100 can provide a reliable, efficient, lightweight, portable generator system which can be used in both commercial and residential applications to provide power at remote locations away from a power grid and for a micro-grid generator, or an ultra-micro-grid generator.

In some examples, the micro hybrid generator system 100 can be used for an applicable application (e.g., robotics, portable generators, micro-grids and ultra-micro-grids, and the like) where an efficient high specific energy power source is required and where a fuel source is readily available to convert hydrocarbon fuels into useable electric power. The micro hybrid generator system 100 has been shown to be significantly more energy efficient than various forms of rechargeable batteries (Lithium Ion, Lithium Polymer, Lithium Sulfur) and even Fuel Cell technologies typically used in conventional UAVs.

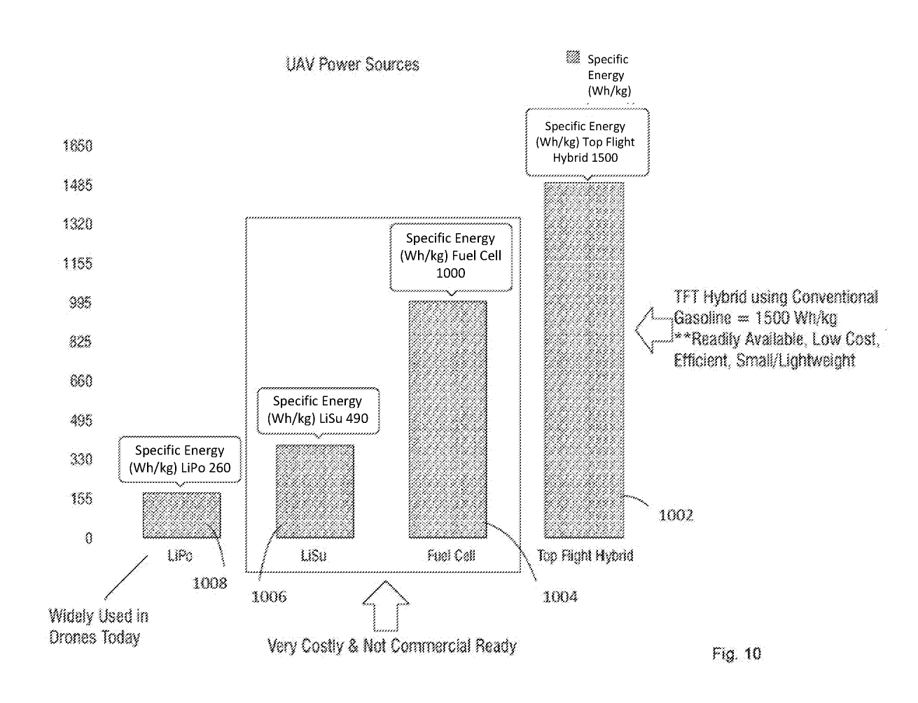

FIG. 10 shows a graph comparing specific energy of different UAV power sources. In some examples, the micro hybrid generator system 100 can use conventional gasoline which is readily available at low cost and provide about 1,500 Wh/kg of power for UAV applications, as indicated at 1002 in FIG. 2. Conventional UAVs which rely entirely on batteries can provide a maximum specific energy of about 1,000 Wh/kg when using a high specific energy fuel cell technology, as indicated at 1004, about 400 Wh/kg when using lithium sulfur batteries, as indicated at 1006, and about 200 Wh/kg when using a LiPo battery, as indicated at 1008.

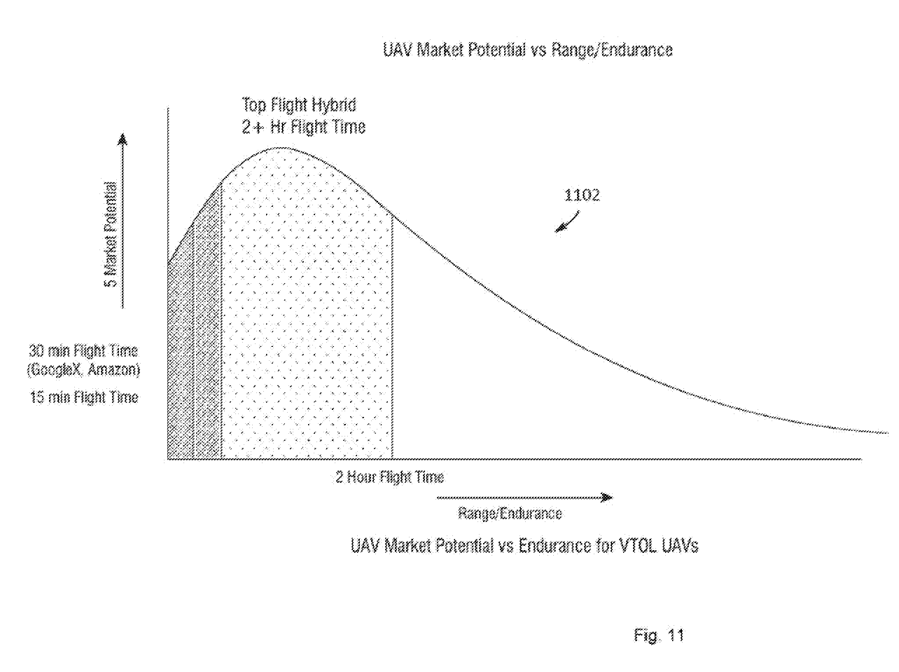

FIG. 11 shows a graph 1104 of market potential for UAVs against flight time for an example two plus hours of flight time micro hybrid generator system 100 when coupled to a UAV is able to achieve and an example of the total market potential vs. endurance for the micro hybrid generator system 100 for UAVs.

In some examples, the micro hybrid generator power systems 100 can be integrated as part of a UAV or similar type aerial robotic vehicle to perform as a portable flying generator using the primary source of power to sustain flight of the UAV and then act as a primary power source of power when the UAV has reached its destination and is not in flight. For example, when a UAV which incorporates the micro hybrid generator power system 100 (e.g., the UAV 900 of FIG. 9) is not in flight, the available power generated by micro hybrid system can be transferred to one or more of external loads 118, 126, 128, and/or 136 such that micro hybrid generator system 100 operates as a portable generator. Micro hybrid system generator 100 can provide continuous peak power generation capability to provide power at remote and often difficult to reach locations. In the “non-flight portable generator mode,” micro hybrid system 100 can divert the available power generation capability towards external one or more of loads 118, 126, 128, and/or 136. Depending on the power requirements, one or more of DC-to-AC inverters 122, 132 may be used to convert DC voltage to standard AC power (120 VAC or 240 VAC).

In some examples, micro hybrid generator system 100 coupled to a UAV (e.g., UAV 900 of FIG. 9) will be able to traverse from location to location using aerial flight, land, and switch on the power generator to convert fuel into power.

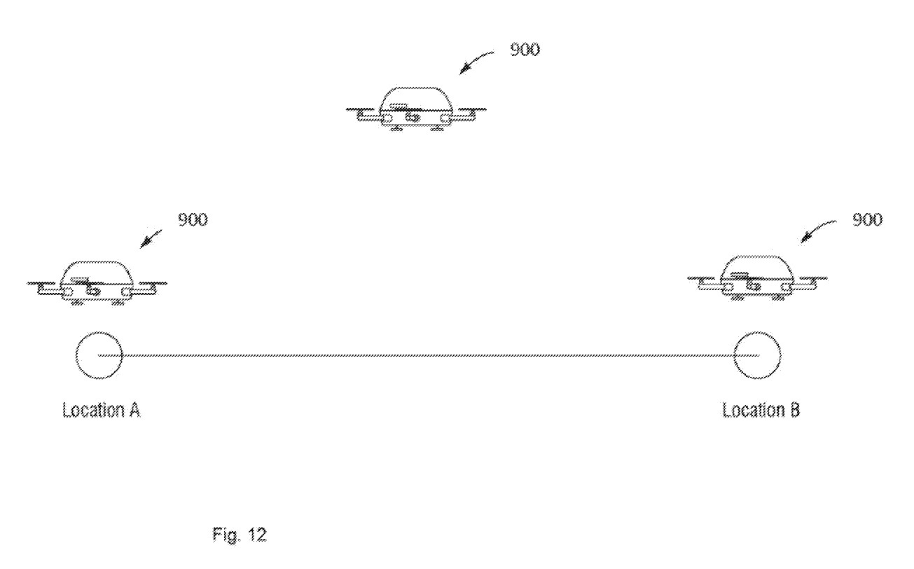

FIG. 12 shows an example flight pattern of a UAV with a micro hybrid generator system 100. In the example flight pattern shown in FIG. 12, the UAV 900, with micro hybrid system 100 coupled thereto, begins at location A loaded with fuel ready to fly. The UAV 900 then travels from location A to location B and lands at location B. The UAV 900 then uses micro hybrid system 100 to generate power for local use at location B, thereby acting as a portable flying generator. When power is no longer needed, the UAV 900 returns back to location A and awaits instructions for the next task.

In some examples, the UAV 900 uses the power provided by micro hybrid generator system 100 to travel from an initial location to a remote location, fly, land, and then generate power at the remote location. Upon completion of the task, the UAV 900 is ready to accept commands for its new task. All of this can be performed manually or through an autonomous/automated process. In some examples, the UAV 900 with micro hybrid generator system 100 can be used in an applicable application where carrying fuel and a local power generator are needed. Thus, the UAV 900 with a micro hybrid generator system 100 eliminates the need to carry both fuel and a generator to a remote location. The UAV 900 with a micro hybrid generator system 100 is capable of powering both the vehicle when in flight, and when not in flight can provide the same amount of available power to external loads. This may be useful in situations where power is needed for the armed forces in the field, in humanitarian or disaster relief situations where transportation of a generator and fuel is challenging, or in situations where there is a request for power that is no longer available, to name a few.

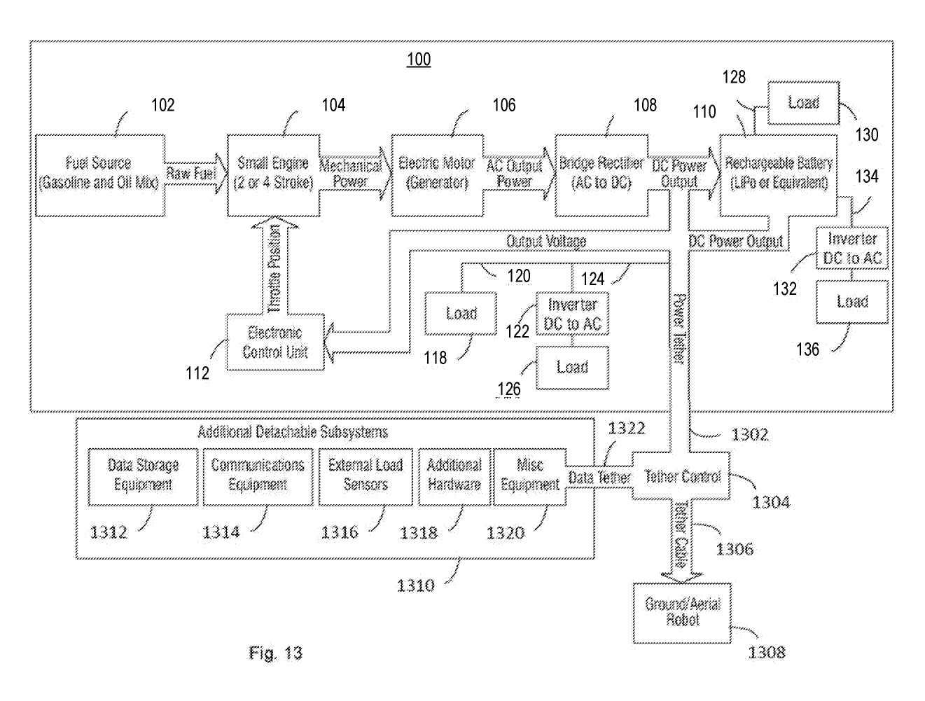

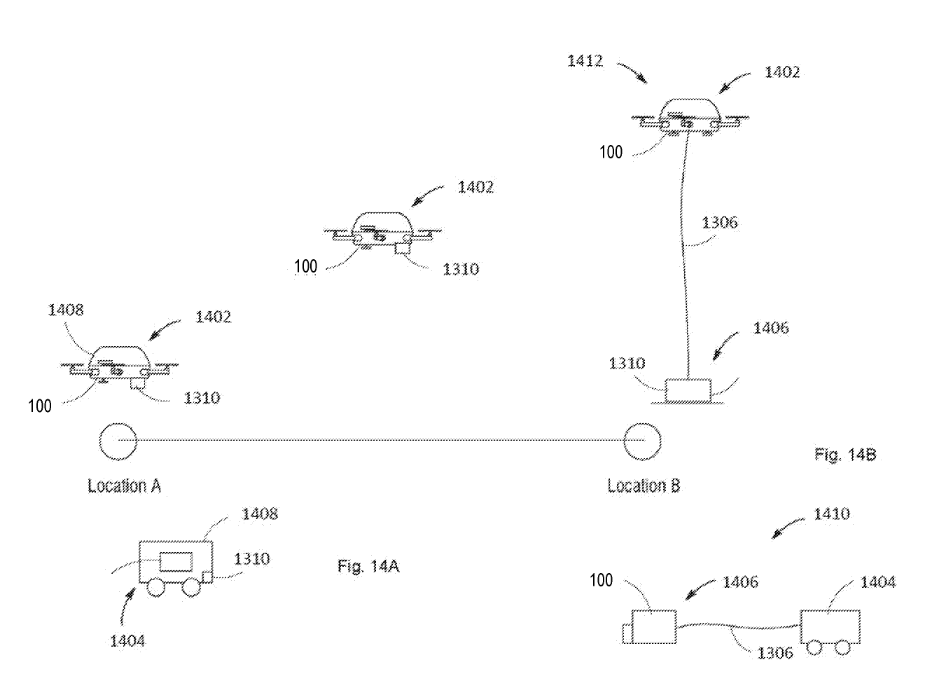

FIG. 13 shows a diagram of another system for a micro hybrid generator system 100 with detachable subsystems. FIG. 14A shows a diagram of a micro hybrid generator system 100 with detachable subsystems integrated as part of a UAV. FIG. 14B shows a diagram of a micro hybrid generator system 100 with detachable subsystems integrated as part of a ground robot. In some examples, a tether line 1302 is coupled to the DC output of bride rectifier 108 and rechargeable battery 110 of a micro hybrid control system 100. The tether line 1302 can provide DC power output to a tether controller 1304. The tether controller 1304 is coupled between a tether cable 1306 and a ground or aerial robot 1308. In operation, as discussed in further detail below, the micro hybrid generator system 100 provides tethered power to the ground or aerial robot 1308 with the similar output capabilities as discussed above with one or more of the figures included herein.

The system shown in FIG. 13 can include additional detachable components 1310 integrated as part of the system. For example, the system can include data storage equipment 1312, communications equipment 1314, external load sensors 1316, additional hardware 1318, and various miscellaneous equipment 1320 that can be coupled via data tether 1322 to tether controller 1304.

In some examples of operation of the system shown in FIG. 13, the system may be configured as part of a flying robot or UAV, such as flying robot or UAV (1402 of FIG. 14), or as ground robot 1404. Portable tethered robotic system 1408 may start a mission at location A. All or an applicable combination of the subsystems and ground, the tether controller, ground/aerial robot 1308 can be powered by the micro hybrid generator system 100. The Portable tethered robotic system 1408 can travel either by ground (e.g., using ground robot 1404 powered by micro hybrid generator system 100) or by air (e.g., using flying robot or UAV 1402 powered by micro hybrid generator system 100) to desired remote location B. At location B, portable tethered robotic system 1408 configured as flying robot 1402 or ground robot 1404 can autonomously decouple micro hybrid generator system 100 and/or detachable subsystem 1310, indicated at 1406, which remain detached while ground robot 1404 or flying robot or UAV 1402 are operational. When flying robot or UAV 1402 is needed at location B, indicated at 1412, flying robot or UAV 1402 can be operated using power provided by micro hybrid generator system coupled to tether cable 1306. When flying robot or UAV 1402 no longer has micro hybrid generator system 100 and/or additional components 1310 attached thereto, it is significantly lighter and can be in flight for a longer period of time. In some examples, flying robot or UAV 1402 can take off and remain in a hovering position remotely for extended periods of time using the power provided by micro hybrid generator system 100.

Similarly, when ground robot 1404 is needed at location B, indicated at 1410, it may be powered by micro hybrid generator system 100 coupled to tether line 1306 and may also be significantly lighter without micro hybrid generator system 100 and/or additional components 1310 attached thereto. Ground robot 1404 can also be used for extended periods of time using the power provide by micro hybrid generator system 100.

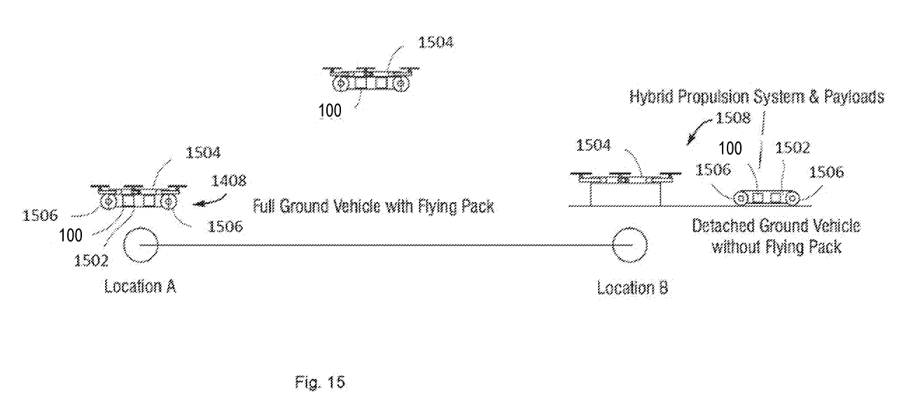

FIG. 15 shows a ground robot 1502 with a detachable flying pack 1504 in operation. The detachable flying pack 1504 includes micro hybrid generator system 100. The detachable flying pack 1504 is coupled to the ground robot 1502 of one or more embodiments. The micro hybrid generator system 100 is embedded within the ground robot 1502. The ground robot 1502 is detachable from the flying pack 1504. With such a design, a majority of the capability may be embedded deep within the ground robot 1502 which can operate 100% independently of the flying pack 1504. When the ground robot 1502 is attached to the flying pack 1504, the flying pack 1504 may be powered from micro hybrid generator system 100 embedded in the ground robot 1502 and the flying pack 1504 provides flight. The ground robot 1502 platform can be a leg wheel or threaded base motion.

In some examples, the ground robot 1502 may include the detachable flying pack 1504 and the micro hybrid generator system 100 coupled thereto as shown in FIG. 15. In the illustrated example, the ground robot 1502 is a wheel-based robot as shown by wheels 1506. In this example, the micro hybrid generator system 100 includes fuel source 102, small engine 104, generator motor 106, bridge rectifier 108, rechargeable battery 110, ECU 112, and optional inverters 122 and 132, as discussed above with reference to one or more figures included herein. The micro hybrid generator system 100 also preferably includes data storage equipment 1312, communications equipment 1314, external load sensors 1316, additional hardware 1318, and miscellaneous communications 1320 coupled to data line 1322 as shown. The flying pack 1504 is preferably an aerial robotic platform such as a fixed wing, single rotor or multi rotor, aerial device, or similar type aerial device.

In some examples, the ground robot 1502 and the aerial flying pack 1504 are configured as a single unit. Power is delivered from micro hybrid generator system 100 and is used to provide power to flying pack 1504, so that ground robot 1502 and flying pack 1504 can fly from location A to location B. At location B, ground robot 1506 detaches from flying pack 1504, indicated at 1508, and is able to maneuver and operate independently from flying pack 1504. Micro hybrid generator system 100 is embedded in ground robot 1502 such that ground robot 1506 is able to be independently powered from flying pack 1504. Upon completion of the ground mission, ground robot 1502 is able to reattached itself to flying pack 1504 and return to location A. All of the above operations can be manual, semi-autonomous, or fully autonomous.

In some examples, flying pack 1504 can traverse to a remote location and deliver ground robot 1502. At the desired location, there may be no need for flying pack 1504. As such, it can be left behind so that ground robot 1502 can complete its mission without having to carry flying pack 1504 as its payload. This may be useful for traversing difficult and challenging terrains, remote locations, and in situations where it is challenging to transport ground robot 1502 to the location. Exemplary applications may include remote mine destinations, remote surveillance and reconnaissance, and package delivery services where flying pack 1504 cannot land near an intended destination. In these examples, a designated safe drop zone for flying pack can be used and local delivery is completed by ground robot 1502 to the destination.

In some examples, upon a mission being completed, ground robot 1404 or flying robot or UAV 1402 can be autonomously coupled back to micro hybrid generator system 100. In some implementations, such coupling is performed automatically upon the mission being completed. Additional detachable components 1310 can be autonomously coupled back micro hybrid generator system 100. Portable tethered robotic system 1408 with a micro hybrid generator system 100 configured a flying robot or UAV 1402 or ground robot 1404 then returns to location A using the power provided by micro hybrid generator system 100.

The result is portable tethered robotic system 1408 with a micro hybrid generator system 100 is able to efficiently transport ground robot 1404 or flying robot or UAV 1402 to remote locations, automatically decouple ground robot 1404 or flying robot or UAV 1402, and effectively operate the flying robot 1402 or ground robot 1404 using tether power where it may be beneficial to maximize the operation time of the ground robot 1402 or flying robot or UAV 1404. System 1408 provides modular detachable tethering which may be effective in reducing the weight of the tethered ground or aerial robot, thereby reducing its power requirements significantly. This allows the aerial robot or UAV or ground robot to operate for significantly longer periods of time when compared to the original capability where the vehicle components are attached and the vehicle needs to sustain motion. System 1408 eliminates the need to assemble a generator, robot and tether at remote locations and therefore saves time, resources, and expense. Useful applications of system 1408 may include, inter alia, remote sensing, offensive or defensive military applications and/or communications networking, multi-vehicle cooperative environments, and the like.

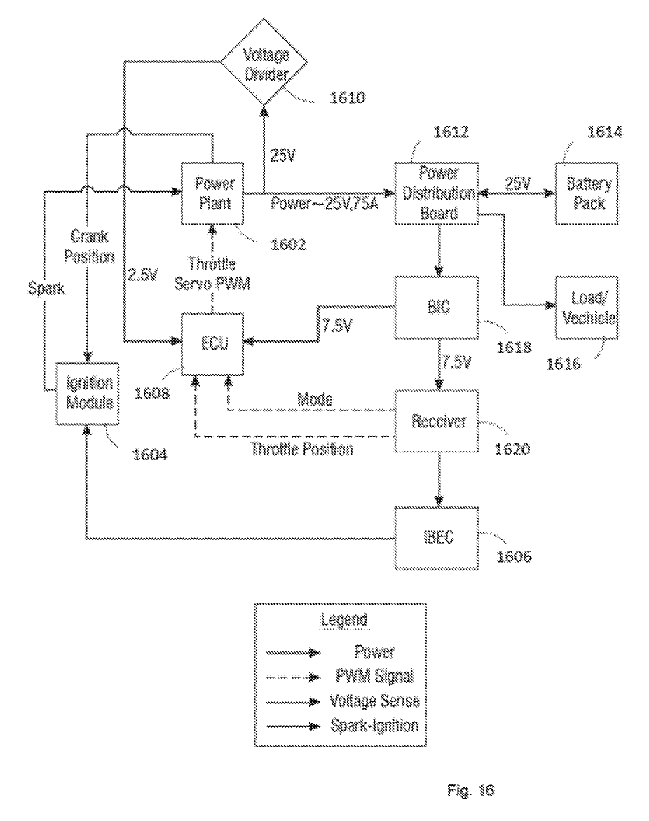

FIG. 16 shows a control system of a micro hybrid generator system. The micro hybrid generator system includes a power plant 1602 coupled to an ignition module 1604. The ignition module 1604 functions to start the power plant 1602 by providing a physical spark to the power plant 1604. The ignition module 1604 is coupled to an ignition battery eliminator circuit (IBEC) 1606. The IBEC 1606 functions to power the ignition module 1604.

The power plant 1602 is configured to provide power. The power plant 1602 includes a small engine and a generator. The power plant is controlled by the ECU 1608. The ECU 1608 is coupled to the power plant through a throttle servo. The ECU 1608 can operate the throttle servo to control a throttle of a small engine to cause the power plant 1602 to either increase or decrease an amount of produced power. The ECU 1608 is coupled to a voltage divider 1610. Through the voltage divider 1610, the ECU can determine an amount of power the ECU 1608 is generating to determine whether to increase, decrease, or keep a throttle of a small engine constant.

The power plant is coupled to a power distribution board 1612. The power distribution board 1612 can distribute power generated by the power plant 1602 to either or both a battery pack 1614 and a load/vehicle 1616. The power distribution board 1612 is coupled to a battery eliminator circuit (BEC) 1618. The BEC 1618 provides power to the ECU 1608 and a receiver 1620. The receiver 1620 controls the IBEC 1606 and functions to cause the IBEC 1606 to power the ignition module 1604. The receiver 1620 also sends information to the ECU 1608 used in controlling a throttle of a small engine of the power plant 1602. The receiver 1620 sends information to the ECU related to a throttle position of a throttle of a small engine and a mode in which the micro hybrid generation system is operating.

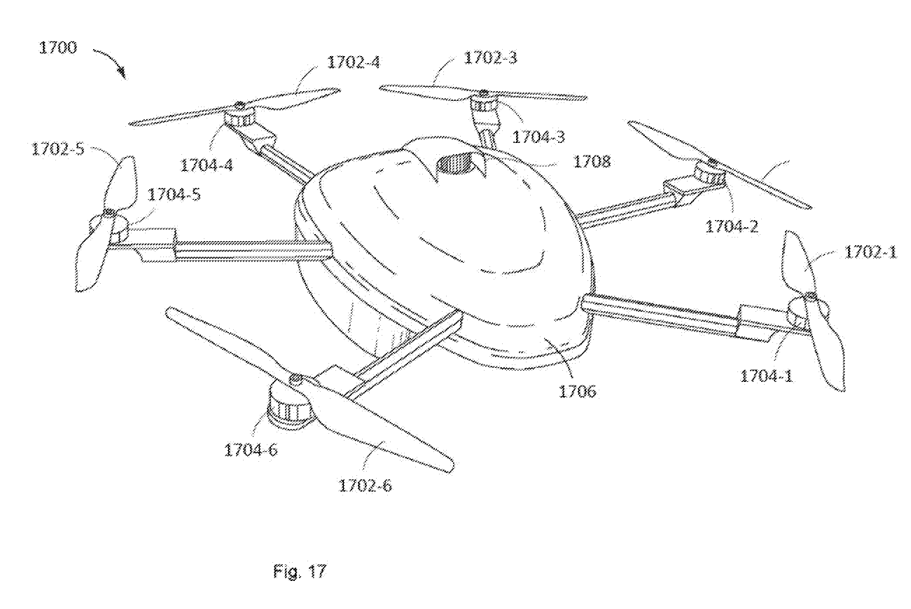

FIG. 17 shows a top perspective view of a top portion 1700 of a drone powered through a micro hybrid generator system. The top portion 1700 of the drone shown in FIG. 13 includes six rotors 1702-1 through 1702-6 (hereinafter “rotors 1702”). The rotors 1702 are caused to spin by corresponding motors 1704-1 through 1704-6 (hereinafter “motors 1704”). The motors 1704 can be powered through a micro hybrid generator system. The top portion 1700 of a drone includes a top surface 1706. Edges of the top surface 1706 can be curved to reduce air drag and improve aerodynamic performance of the drone. The top surface includes an opening 1708 through which air can flow to aid in dissipating heat away from at least a portion of a micro hybrid generator system. In various embodiments, at least a portion of an air filter is exposed through the opening 1708.

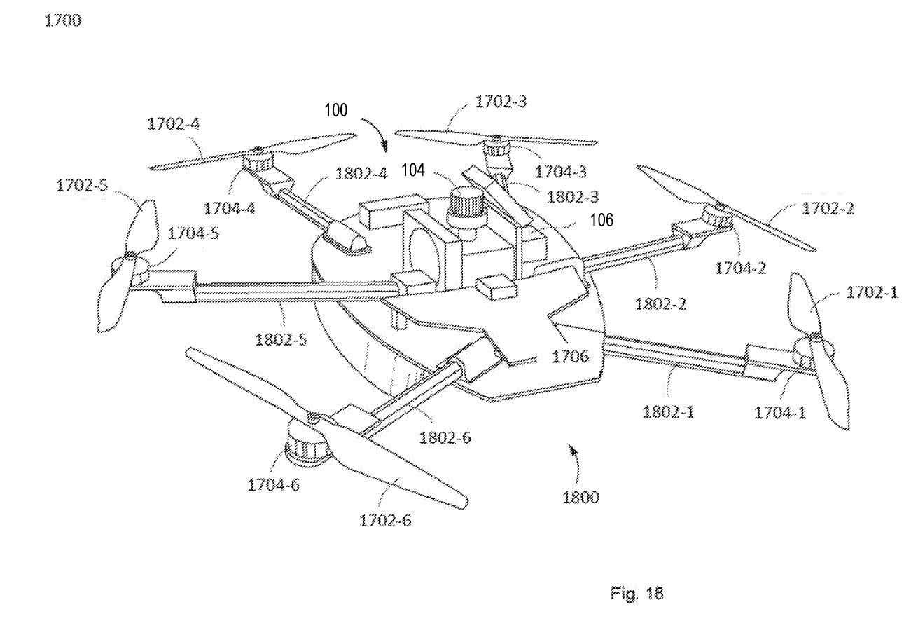

FIG. 18 shows a top perspective view of a bottom portion 1800 of a drone powered through a micro hybrid generator system 100. The micro hybrid generator system 100 includes a small engine 104 and a generator motor 106 to provide power to motors 1704. The rotor motors 1704 and corresponding rotors 1702 are positioned away from a main body of a bottom portion 1800 of the drone through arms 1802-1 through 1802-6 (hereinafter “arms 1802”). An outer surface of the bottom portion of the bottom portion 1800 of the drone and/or the arms 1802 can have edges that are curved to reduce air drag and improve aerodynamic performance of the drone.

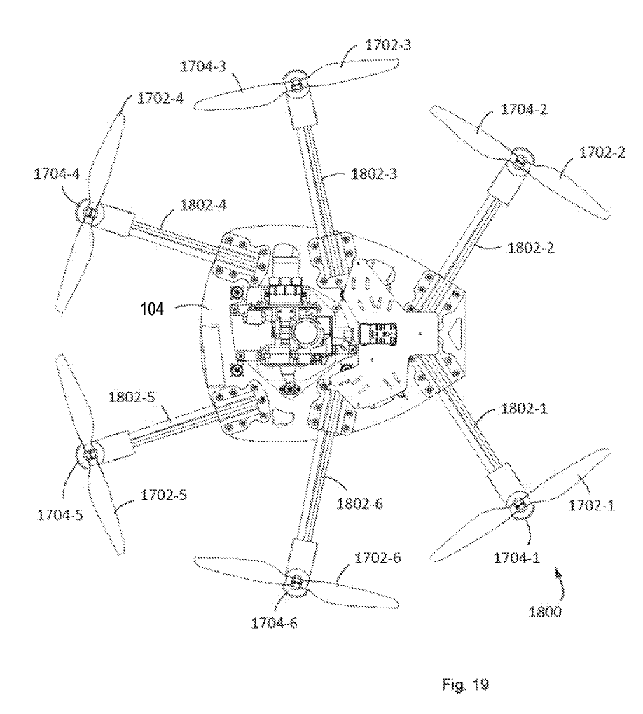

FIG. 19 shows a top view of a bottom portion 1800 of a drone powered through a micro hybrid generator system 100. The rotor motors 1704 and corresponding rotors 1702 are positioned away from a main body of a bottom portion 1800 of the drone through arms 1802. An outer surface of the bottom portion of the bottom portion 1800 of the drone and/or the arms 1802 can have edges that are curved to reduce air drag and improve aerodynamic performance of the drone.

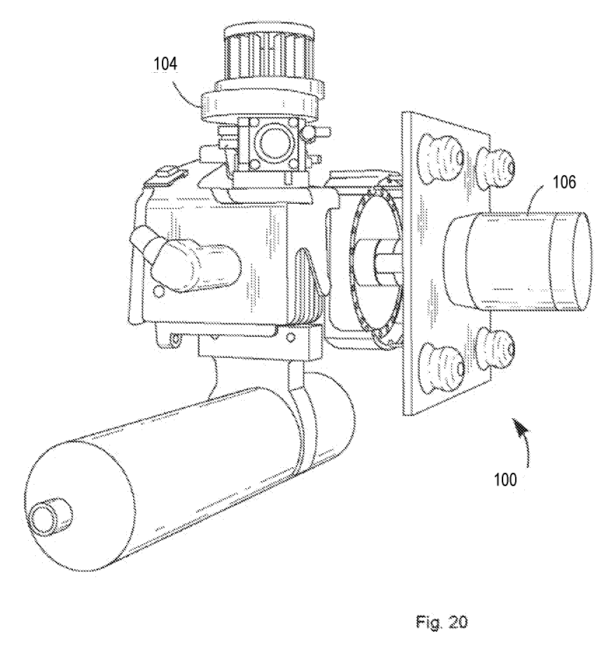

FIG. 20 shows a side perspective view of a micro hybrid generator system 100. The micro hybrid generator system 100 shown in FIG. 20 is capable of providing 1.8 kW of power. The micro hybrid generator system 100 include a small engine 104 coupled to a generator motor 106. The small engine 104 can provide approximately 3 horsepower. The generator motor 106 functions to generate AC output power using mechanical power generated by the small engine 104.

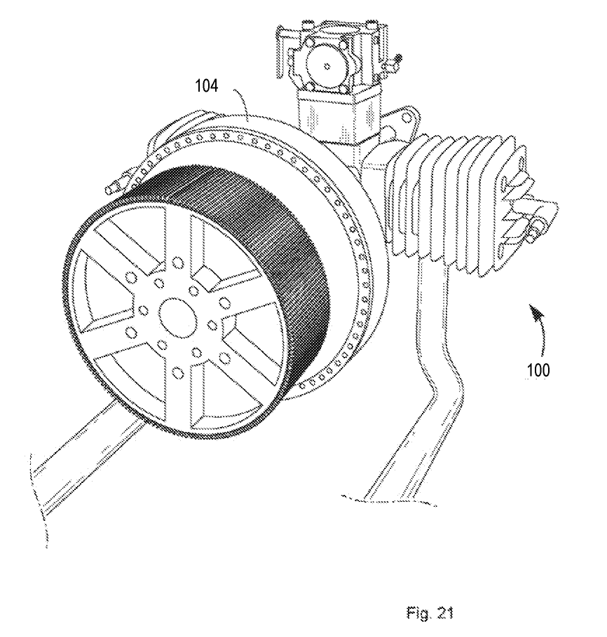

FIG. 21 shows a side perspective view of a micro hybrid generator system 100. The micro hybrid generator system 100 shown in FIG. 21 is capable of providing 10 kW of power. The micro hybrid generator system 100 include a small engine 104 coupled to a generator motor. The small engine 104 can provide approximately 15-16.5 horsepower. The generator motor functions to generate AC output power using mechanical power generated by the small engine 104.

Further description of UAVs and micro hybrid generator systems can be found in U.S. application Ser. No. 14/942,600, filed on Nov. 16, 2015, the contents of which are incorporated here by reference in their entirety.

In some examples, the small engine 104 can include features that enable the engine to operate with high specific power. The small engine 104 can be a two-stroke engine having a high power-to-weight ratio. The small engine 104 can embody a simply design with a small number of moving parts such that the engine is small and light, thus contributing to the high power-to-weight ratio of the engine. In some examples, the small engine may have a specific energy of 1 kW/kg (kilowatt per kilogram) and generate about 10 kg of lift for every kilowatt of power generated by the small engine. In some examples, the small engine 104 can be a brushless motor, which can contribute to achieving a high specific power of the engine. A brushless motor is efficient and reliable, and is generally not prone to sparking, thus reducing the risk of electromagnetic interference (EMI) from the engine.

In some examples, the small engine 104 is mounted on the UAV via a vibration isolation system that enables sensitive components of the UAV to be isolated from vibrations generated by the engine. Sensitive components of the UAV can include, e.g., an inertial measurement unit such as Pixhawk, a compass, a global positioning system (GPS), or other components.

In some examples, the vibration isolation system can include vibration damping mounts that attach the small engine to the frame of the UAV. The vibration damping mounts allow for the engine 104 to oscillate independently from the frame of the UAV, thus preventing vibrations from being transmitted from the engine to other components of the UAV. The vibration damping mounts can be formed from a robust, energy absorbing material such as rubber, that can absorb the mechanical energy generated by the motion of the engine without tearing or ripping, thus preventing the mechanical energy from being transferred to the rest of the UAV. In some examples, the vibration damping mounts can be formed of two layers of rubber dampers joined together rigidly with a spacer. The length of the spacer can be adjusted to achieve a desired stiffness for the mount. The hardness of the rubber can be adjusted to achieve desired damping characteristics in order to absorb vibrational energy.

Referring to FIG. 22A, in some examples, the small engine 104 and the generator motor 106 are directly coupled through a precise and robust connection (e.g., through a urethane coupling 304). In particular, the generator motor 106 includes a generator rotor 306 and a generator stator 308 housed in a generator body 2202. The generator rotor 306 is attached to the generator body 2202 by generator bearings 2204. The generator rotor 306 is coupled to an engine shaft 206 via the coupling 304. Precision coupling between the small engine 104 and the generator motor 106 can be achieved by using precisely machined parts and balancing the weight and support of the rotating components of the generator motor 106, which in turn reduces internal stresses. Alignment of the generator rotor 306 with the engine shaft 206 can also help to achieve precision coupling. Misalignment between the rotor 306 and the engine shaft 206 can cause imbalances that can reduce efficiency and potentially lead to premature failure. In some examples, alignment of the rotor 306 with the engine shaft 206 can be achieved using precise indicators and fixtures. Precision coupling can be maintained by cooling the small engine 104 and generator motor 106, by reducing external stresses, and by running the small engine 104 and generator motor 106 under steady conditions, to the extent possible. For instance, the vibration isolation mounts allow external stresses on the small engine 104 to be reduced or substantially eliminated, assisting in achieving precision direct coupling.

Direct coupling can contribute to the reliability of the first power system, which in turn enables the micro hybrid generator system to operate continuously for long periods of time at high power. In addition, direct coupling can contribute to the durability of the first power system, thus helping to reduce mechanical creep and fatigue even over many engine cycles (e.g., millions of engine cycles). In some examples, the engine is mechanically isolated from the frame of the UAV by the vibration isolation system and thus experiences minimal external forces, so the direct coupling between the engine and the generator motor can be implemented by taking into account only internal stresses.

Direct coupling between the small engine 104 and the generator motor 106 can enable the first power system to be a compact, lightweight power system having a small form factor. A compact and lightweight power system can be readily integrated into the UAV.

Referring to FIG. 22B, in some examples, a frameless or bearing-less generator 208 can be used instead of a urethane coupling between the generator motor 106 and the small engine 104. For instance, the bearings (2204 in FIG. 22A) on the generator can be removed and the generator rotor 306 can be directly mated to the engine shaft 206. The generator stator 308 can be fixed to a frame 210 of the engine 116. This configuration prevents over-constraining the generator with a coupling while providing a small form factor and reduced weight and complexity.

In some examples, the generator motor 106 includes a flywheel that provides a large rotational moment of inertia. A large rotational inertia can result in reduced torque spikes and smooth power output, thus reducing wear on the coupling between the small engine 104 and the generator motor 106 and contributing to the reliability of the first power system. In some examples, the generator, when mated directly to the small engine 104, acts as a flywheel. In some examples, the flywheel is a distinct component (e.g., if the generator does not provide enough rotary inertia).

In some examples, design criteria are set to provide good pairing between the small engine 104 and the generator motor 106. The power band of a motor is typically limited to a small range. This power band can be used to identify an RPM (revolutions per minute) range within which to operate under most flight conditions. Based on the identified RPM range, a generator can be selected that has a motor constant (kV) that is able to provide the appropriate voltage for the propulsion system (e.g., the rotors). The selection of an appropriate generator helps to ensure that the voltage out of the generator will not drop as the load increases. For instance, if the engine has maximum power at 6500 RPM, and a 50 V system is desired for propulsion, then a generator can be selected that has a kV of 130.

In some examples, exhaust pipes can be designed to positively affect the efficiency of the small engine 104. Exhaust pipes serve as an expansion chamber for exhaust from the engine, thus improving the volumetric efficiency of the engine. The shape of the exhaust pipes can be tuned to guide air back into the combustion chamber based on the resonance of the system. In some examples, the carburetor can also be tuned based on operating parameters of the engine, such as temperature or other parameters. For instance, the carburetor can be tuned to allow a desired amount of fuel into the engine, thus enabling a target fuel to air ratio to be reached in order to achieve a good combustion reaction in the engine. In addition, the throttle body can be designed to control fuel injection and/or timing in order to further improve engine output.

In some examples, the throttle of the engine can be regulated in order to achieve a desired engine performance. For instance, when the voltage of the system drops under a load, the throttle is increased; when the voltage of the system becomes too high, the throttle is decreased. The bus voltage can be regulated and a feedback control loop used to control the throttle position. In some examples, the current flow into the battery can be monitored with the goal of controlling the charge of the battery and the propulsion voltage. In some examples, feed forward controls can be provided such that the engine can anticipate upcoming changes in load (e.g., based on a mission plan and/or based on the load drawn by the motor) and preemptively compensates for the anticipated changes. Feed forward controls can enable the engine to respond to changes in load with less lag. In some examples, the engine can be controlled to charge the battery according to a pre-specified schedule, e.g., to maximize battery life, in anticipation of loads (e.g., loads forecast in a mission plan), or another goal. Throttle regulation can help keep the battery fully charged, helping to ensure that the system can run at a desired voltage and helping to ensure that backup power is available.

In some examples, ultra-capacitors can be incorporated into the micro hybrid generator system in order to allow the micro hybrid generator system to respond quickly to changing power demands. For instance, ultra-capacitors can be used in conjunction with one or more rechargeable batteries to provide a lightweight system capable of rapid response and smooth, reliable power.

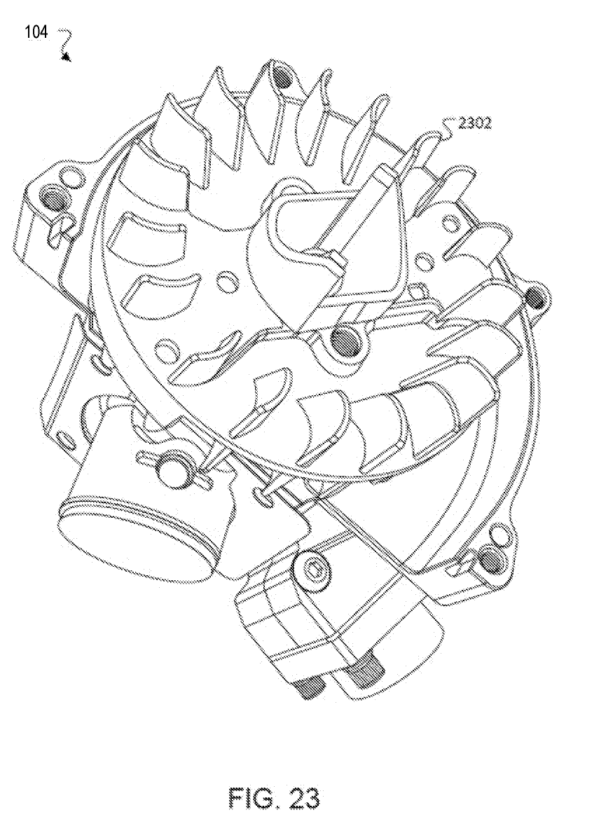

FIG. 23 shows a diagram of an example small engine 104 of the micro hybrid generator system. In this example, the small engine 104 includes a plurality of fins 2302 formed on the engine (e.g., on one or more of the cylinder heads of the engine) to increase the convective surface area of the engine, thereby enabling increased heat transfer. In some examples, the micro hybrid generator system can be configured such that certain components are selectively exposed to ambient air or to air flow generated by the flying motion of the UAV in order to further cool the components.

While the cooling systems (e.g., the active cooling systems and passive cooling systems) have largely been described as being incorporated into a micro hybrid generator system employed as part of a UAV, in some implementations, such cooling systems may be incorporated into micro hybrid generator systems employed as part of other types of aerial vehicles. Similarly, in some implementations, such cooling systems may be incorporated into other types of power systems used to power the UAV.

In some examples, the materials of the micro hybrid generator system 100 and/or the UAV can be lightweight. For instance, materials with a high strength to weight ratio can be used to reduce weight. Example materials can include aluminum or high strength aluminum alloys (e.g., 7075 alloy), carbon fiber based materials, or other materials. Component design can also contribute to weight reduction. For instance, components can be designed to increase the stiffness and reduce the amount of material used for the components. In some examples, components can be designed such that material that is not relevant for the functioning of the component is removed, thus further reducing the weight of the component.

While the UAV has been largely described as being powered by a micro hybrid generator system that includes a gasoline powered engine coupled to a generator motor, other types of power systems may also be used. In some implementations, the UAV may be powered at least in part by a turbine, such as a gasoline turbine. For example, a gasoline turbine can be used in place of the gasoline powered engine. The gasoline turbine may be one of two separate power systems included as part of the micro hybrid generator system. That is, the micro hybrid generator system can include a first power system in the form of a gasoline turbine and a second power system in the form of a generator motor. The gasoline turbine may be coupled to the generator motor.

The gasoline turbine may provide higher RPM levels than those provided by a gasoline powered engine (e.g., the small engine 104 described above). Such higher RPM capability may allow a second power system (e.g., the generator motor 106 described above) to generate electricity (e.g., for charging the battery 110 described above) more quickly and efficiently.

The gasoline turbine, sometimes referred to as a combustion turbine, may include an upstream rotation compressor coupled to a downstream turbine with a combustion chamber therebetween. The gasoline turbine may be configured to allow atmospheric air to flow through the compressor, thereby increasing the pressure of the air. Energy may then be added by applying (e.g., spraying) fuel, such as gasoline, into the air and igniting the fuel in order to generate a high-temperature flow. The high-temperature and high-pressure gas flow may then enter the turbine, where the gas flow can expand down to the exhaust pressure, thereby producing a shaft work output. The turbine shaft work is then used to drive the compressor and other devices, such as a generator (e.g., the generator motor 504) that may be coupled to the shaft. Energy that is not used for shaft work can be expelled as exhaust gases having one or both of a high temperature and a high velocity. One or more properties and/or dimensions of the gas turbine design can be chosen such that the most desirable energy form is maximized. In the case of use with a UAV, the gas turbine will typically be optimized to produce thrust from the exhaust gas or from ducted fans connected to the gas turbines.

The gasoline turbine may generate a relatively large amount of heat (e.g., as compared to the heat generated by a gasoline powered engine), in part due to the higher RPM capability of the gasoline turbine. The cooling systems described herein may be used to ensure that the gasoline turbine does not exceed acceptable temperature limits. Such cooling may be especially important for implementations that use a gasoline turbine in order to extend the lifetime of the turbine, maintain the efficiency of the turbine, etc.

In some implementations, one or more turbine inlet air cooling techniques may also be employed to further reduce the operating temperature of the gasoline turbine. Such techniques may be used to cool down the intake air of the gasoline turbine, the direct consequence of which can include power output augmentation, improved energy efficiency, etc. The performance, efficiency, generated power output, etc. of a gasoline turbine may depend on climate conditions (e.g., the temperature, density, pressure, etc. of ambient and intake air). Turbine inlet air cooling strategies can serve to adjust one or more characteristics of the air in order to put the air in condition for improved gasoline turbine performance. Such cooling techniques may be especially helpful in climates with high ambient temperatures.

In some implementations, a fogging technique may be employed. Inlet air fogging may include spraying finely atomized water (e.g., fog) into the inlet airflow. The water evaporates quickly, thereby cooling the air and increasing the power output of the turbine. For example, demineralized water may be pressurized and injected at the air inlet (e.g., through one or more fog nozzles). Use of demineralized water can prevent fouling of components of the gasoline turbine that may occur if water with mineral content were evaporated in the airflow. In some implementations, excess fog (e.g., more fog than is required to fully saturate the inlet air) may be provided, and the excess fog droplets can be carried into the compressor of the gasoline turbine where they can evaporate and produce an intercooling effect, thereby resulting in a further power boost.

In some implementations, an evaporating cooling technique may be employed. A wetted rigid media where water can be distributed throughout a header and where air passes through a wet porous surface (e.g., sometimes called an evaporative cooler) can be positioned proximate to the gasoline turbine. As the air passes through, part of the water is evaporated, absorbing the sensible heat from the air and increasing its relative humidity. The air dry-bulb temperature may be decreased while the wet-bulb temperature is not affected.

In some implementations, one or both of a vapor compression chiller and a vapor absorption chiller may be employed in the gasoline turbine. In vapor compression chiller technology, coolant can be circulated through a chilling coil heat exchanger. A droplet catcher can be installed downstream from the coil to collect moisture and water droplets. The mechanical chiller can increase the output power and performance of the gasoline turbine (e.g., more so than wetted technologies) due to the ability of the inlet air to be chilled below the wet-bulb temperature irrespective of weather conditions. In some implementations, multiple chilling coils and droplet catchers (e.g., sometimes collectively referred to as “chiller units”) can be used.

In vapor absorption chiller technology, thermal energy can be used to produce cooling instead of mechanical energy. For example, leftover heat produced by the gasoline turbine may serve as a heat source for driving the cooling system.

In some implementations, a thermal energy storage tank may be used with one or more of the cooling techniques described above. The thermal energy storage tank may allow for the storage of chilled water which may be produced during off-peak times (e.g., times when weather conditions are optimal, times when maximum performance and efficiency are not needed, times when the UAV is engaged in short-range flight, etc.). The energy may be used later, such as during on-peak times (e.g., times when weather conditions are not optimal, times when maximum performance and efficiency are required, times when the UAV needs to travel relatively large distances, etc.) in order to chill the turbine inlet air and improve power output. For example, excess power from the gasoline turbine can be used to produce chilled water during a warm-up flight before the UAV embarks on a relatively long journey, and the chilled water can be used later to improve performance, efficiency, and power output during the journey.

In some implementations, blades of the turbine may be designed to maintain a relatively low heat and/or may employ one or more blade cooling techniques. In some examples, the turbine blades may include a heat-resistant material. For example, the blades may have a shell made from a heat-resistant material and the shell may be filled with a blade alloy.

In some implementations, a convection cooling technique may be employed in the blades. Cool air can be passed through passages internal to the blade. Heat is transferred by conduction through the blade, and then by convection into the air flowing inside of the blade. Increased surface area of the blade may improve the cooling. As such, the cooling paths may be serpentine and include a plurality of small fins. In some implementations, the internal passages in the blade may be circular or elliptical in shape. Cooling can be achieved by passing the air through such passages from a hub toward a blade tip. The cooling air may be provided by an air compressor.

In some implementations, an impingement cooling technique may be employed in the blades. Air, sometimes having a relatively high velocity, may be provided to an inner surface of the blade, thereby allowing more heat to be transferred by convection as compared to regular convection cooling. Impingement cooling may be employed in regions of the blades that have the greatest heat loads (e.g., the leading edges).

In some implementations, a film cooling technique may be employed in the blades. The blades may include small holes, and cooling air may be pumped out of the blade through such holes. A thin layer of cooling air is then created on the external surface of the blade, thereby reducing the heat transfer from main flow. The air holes may be positioned at various locations of the blade. In some implementations, the air holes are predominantly positioned at the leading edges of the blades, where the greatest heat loads are typically found.

In some implementations, a cooling effusion technique may be employed in the blades. Surfaces of the blades may be made from a porous material having a plurality of small orifices on the surface. Cooling air can be forced through the orifices, thereby creating a film or cooler boundary layer.

In some implementations, a pin fin cooling technique may be employed in the blades. The blades may include an array of pin fins on the blade surfaces. Heat transfer can take place from the array and through the side walls of the blade. As coolant flows across the pin fins (e.g., with high velocity), the air flow separates, thereby creating wakes. Such a technique may be employed in the narrow trailing edge of the blade.

In some implementations, a transpiration cooling technique may be employed in the blades. Such a technique is similar to film cooling in that it creates a thin film of cooling air on the blade, but is different in that air is leaked through a porous shell rather than injected through holes. Such a technique may uniformly cover the entire blade with cool air, making it especially effective at relatively high temperatures. Blades that employ transpiration cooling may include a rigid strut with a porous shell. Air can flow through internal channels of the strut and pass through the porous shell to cool the blade.

While a number of cooling techniques have been individually described above, it should be understood that any combination of the cooling techniques described herein may be employed to provide cooling to the power system as required for the particular implementation of the power system and/or the UAV.

A number of embodiments have been described. Nevertheless, it will be understood that various modifications may be made without departing from the spirit and scope of the subject matter described herein. Other such embodiments are within the scope of the following claims.

What is claimed is:

1. An unmanned aerial vehicle comprising:
at least one rotor motor configured to drive at least one propeller to rotate;
a micro hybrid generator system configured to provide power to the at least one rotor motor, the micro hybrid generator system comprising:
a rechargeable battery configured to provide power to the at least one rotor motor;
a small engine configured to generate mechanical power; and
a generator motor coupled to the small engine and configured to generate electrical power from the mechanical power generated by the small engine; and
a cooling system configured to couple to the micro hybrid generator system, the cooling system comprising:
one or more plates; and
a plurality of fins extending from each of the one or more plates,
wherein the cooling system is configured to dissipate heat from the micro hybrid generator system.

2. The unmanned aerial vehicle of claim 1, wherein the one or more plates are configured to couple to the small engine.

3. The unmanned aerial vehicle of claim 1, wherein at least one of the plates and the corresponding plurality of fins is positioned substantially beneath one of the propellers.

4. The unmanned aerial vehicle of claim 1, wherein the plurality of fins extend in a perpendicular direction from the one or more plates.

5. The unmanned aerial vehicle of claim 1, wherein the plates are physically coupled to the small engine.

6. The unmanned aerial vehicle of claim 1, wherein the plates are coupled to the generator motor.

7. The unmanned aerial vehicle of claim 1, wherein the cooling system comprises an impeller.

8. The unmanned aerial vehicle of claim 7, wherein the impeller is coupled to the small engine.

9. The unmanned aerial vehicle of claim 7, wherein the impeller is coupled to the rotor motor.

10. The unmanned aerial vehicle of claim 1, wherein the plates are coupled to one or more exhaust pipes of the small engine.

11. The unmanned aerial vehicle of claim 1, wherein the plates are formed of metal.

12. The unmanned aerial vehicle of claim 1, wherein the fins comprise multiple groups of fins, each group of fins extending from a corresponding surface of one of the plates.

13. The unmanned aerial vehicle of claim 1, wherein the fins are spaced equally.

14. The unmanned aerial vehicle of claim 1, wherein fins located at the perimeter of each plate are fanned away from fins located in an interior region of the surface of the plate.

15. The unmanned aerial vehicle of claim 1, wherein the one or more plates are positioned below the at least one propeller.

16. A method comprising:
operating a hybrid energy generation system to provide electrical energy to a rotor motor configured to drive rotation of a propeller of an unmanned aerial vehicle, comprising:
generating mechanical energy in an engine of the hybrid electrical energy generation system;
in a generator of the hybrid energy generation system, converting the mechanical energy into electrical energy;
providing at least some of the electrical energy produced by the generator to a rechargeable battery of the hybrid energy generation system; and
one or more of (i) providing at least some of the electrical energy produced by the generator to the rotor motor of the hybrid energy generation system and (ii) providing electrical energy from the rechargeable battery of the hybrid energy generation system to the rotor motor; and
cooling the hybrid energy generation by dissipation of heat to a cooling system, the cooling system comprising:
one or more plates; and
a plurality of fins extending from each of the one or more plates.
